(19) United States
(12) Patent Application Publication
(10) Pub. No.: US 2022/0290999 A1
(43) Pub. Date: Sep. 15, 2022

(54) MOBILITY AS A SERVICE (MAAS) PLATFORM

(71) Applicant: Cubic Corporation, San Diego, CA (US)

(72) Inventors: Aravind Asam, San Diego, CA (US); Alexander Wilhelm, San Francisco, CA (US); Carina Nicklaw, San Marcos, CA (US); Frederick Rodolfo, Chula Vista, CA (US); Dongwook Kim, Poway, CA (US); Anand Kulkarni, Cypress, CA (US); Bruno Alves, San Diego, CA (US); Aaron Bannister, Portland, OR (US); Rakesh Prasad, San Diego, CA (US); Chintan Gokani, San Ramon, CA (US); Santhosh Kumar Doddi, Telangana (IN); Divya Komadam, Telangana (IN); Katherine Aurelia, Austin, TX (US)

(21) Appl. No.: 17/711,835

(22) Filed: Apr. 1, 2022

Related U.S. Application Data
(63) Continuation of application No. PCT/IN2022/050065, filed on Jan. 27, 2022.
(60) Provisional application No. 63/142,473, filed on Jan. 27, 2021.

(51) Int. Cl. G01C 21/34; G06Q 10/04

(52) U.S. Cl. CPC G01C 21/3453; G06Q 10/047

(57) ABSTRACT

A method of implementing a mobility as a service policy may include associating an identifier with a mobility service policy. The method may include assigning the mobility service policy to at least one mobility service provider of a plurality of mobility service providers. The method may include setting at least one usage restriction for the mobility service policy. The at least one usage restriction may limit operation of the at least one mobility service provider when the policy is activated. The method may include setting a geographical restriction associated with the mobility service policy. The method may include setting a time restriction associated with when the mobility service policy is to be active. The method may include enabling the mobility service policy.

### CROSS-REFERENCES TO RELATED APPLICATIONS

This application is a continuation of PCT Application No. PCT/IN2022/050065, filed Jan. 27, 2022, which claims the benefit of U.S. Provisional Application Ser. No. 63/142,473, filed on Jan. 27, 2021, the disclosures of which are incorporated by reference herein in their entireties.

### BACKGROUND OF THE INVENTION

Although managing authorities and mobility service providers may work together to provide travelers an assortment of mobility services, there are difficulties in doing so. Technical obstacles arise, for example, when each entity operate their own proprietary services with different computing systems. While these systems are individually usable by travelers using personal computing and/or mobile devices, each individual solution typically has a unique application programming interface (API) that prevents the various systems from being integrated into a single interface. As such, enabling multiple mobile solutions to have interoperability with one another may require months of customized integrations to allow these systems to work together effectively. Therefore, improvements in all-in-one mobile service solutions are desired.

### BRIEF SUMMARY OF THE INVENTION

A method of implementing a mobility as a service policy may include associating an identifier with a mobility service policy. The method may include assigning the mobility service policy to at least one mobility service provider of a plurality of mobility service providers. The method may include setting at least one usage restriction for the mobility service policy. The at least one usage restriction may limit operation of the at least one mobility service provider when the policy is activated. The method may include setting a geographical restriction associated with the mobility service policy. The method may include setting a time restriction associated with when the mobility service policy is to be active. The method may include enabling the mobility service policy.

In some embodiments, the method may include determining a policy objective to achieve. The method may include selecting at least one of the usage restriction, the geographical restriction, and the time restriction based on the policy objective. The method may include appending the mobility service policy to a log of prior mobility service policies. The method may include receiving an approval of the mobility service policy from the at least one mobility service provider. The mobility service policy may be based at least in part on historical usage data of the plurality of mobility service providers. Enabling the mobility service policy may include communicating a policy contract to each of the at least one mobility service provider.

Some embodiments of the present technology may encompass a mobility as a service computing system. The computing system may include a communication interface. The computing system may include one or more processors. The computing system may include a memory containing instructions thereon. When executed, the instructions may cause the one or more processors to associate an identifier with a mobility service policy. The instructions may cause the one or more processors to assign the mobility service policy to at least one mobility service provider of a plurality of mobility service providers. The instructions may cause the one or more processors to set at least one usage restriction for the mobility service policy. The at least one usage restriction may limit operation of the at least one mobility service provider when the policy is activated. The instructions may cause the one or more processors to set a geographical restriction associated with the mobility service policy. The instructions may cause the one or more processors to set a time restriction associated with when the mobility service policy is to be active. The instructions may cause the one or more processors to enable the mobility service policy.

In some embodiments, the geographical restriction may limit operation within an area that may include at least one area of the group consisting of a radius around one or more points of interest, a drawn in boundary, a geofenced area, and a set of one or more roadways. Setting the time restriction may include setting a recurring time period for the mobility service policy to be active. The at least one mobility service provider may include all of the plurality of mobility service providers that fall into a particular provider type. The particular provider type may be selected from the group consisting of a rideshare service, a ride-hailing service, and a user-operated vehicle service. The instructions may further cause the one or more processors to submit the mobility service policy to a journey planning service. The instructions may further cause the one or more processors to present a log of current mobility service policies on a display device.

Some embodiments of the present technology may encompass a non-transitory computer-readable medium having instructions stored thereon. When executed, the instructions may cause the one or more processors to associate an identifier with a mobility service policy. The instructions may cause the one or more processors to assign the mobility service policy to at least one mobility service provider of a plurality of mobility service providers. The instructions may cause the one or more processors to set at least one usage restriction for the mobility service policy. The at least one usage restriction may limit operation of the at least one mobility service provider when the policy is activated. The instructions may cause the one or more processors to set a geographical restriction associated with the mobility service policy. The instructions may cause the one or more processors to set a time restriction associated with when the mobility service policy is to be active. The instructions may cause the one or more processors to enable the mobility service policy.

In some embodiments, the instructions may further cause the one or more processors to append the mobility service policy to a log of prior mobility service policies. The instructions may further cause the one or more processors to receive an approval of the mobility service policy from the at least one mobility service provider. The instructions may further cause the one or more processors to submit the mobility service policy to a journey planning service. The instructions may further cause the one or more processors to present a log of current mobility service policies on a display device.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a set of parentheses containing a second label that distinguishes among the similar components. If only the first reference label is used in the specification, the description is applicable to any one of the similar components having the same first reference label irrespective of the second reference label.

FIG. 1 is a block diagram of a MaaS system capable of providing users with a variety of mobility/transportation services according to an embodiment of the present invention.

FIG. 2A illustrates a flowchart of a process for mobility service providers using a mobility as a service platform according to embodiments of the present invention.

FIG. 2B illustrates a flowchart of an approval process for mobility service policies according to embodiments of the present invention.

FIGS. 3A and 3B illustrate a dashboard utilized by a managing authority to view various metrics of one or more mobility service providers according to embodiments of the present invention.

FIGS. 4A-4I illustrate a journeys interface according to embodiments of the present invention.

FIGS. 5A-5D illustrate a partners dashboard according to embodiments of the present invention.

FIGS. 6A-6H illustrate a policy dashboard according to embodiments of the present invention.

FIGS. 7A-7E illustrate a transactions dashboard according to embodiments of the present invention.

FIGS. 8A-8C illustrate a journey planning interface according to embodiments of the present invention.

FIGS. 9A and 9B illustrate a journey booking interface according to embodiments of the present invention.

FIGS. 10A-10C illustrate a live journey interface according to embodiments of the present invention.

FIGS. 11A and 11B illustrate a journey review interface according to embodiments of the present invention.

FIG. 12 is a flowchart of a process for implementing a mobility as a service policy according to embodiments of the present invention.

FIG. 13 is a block diagram of a computing system according to embodiments of the present invention.

### DETAILED DESCRIPTION OF THE INVENTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

In the world of transportation and mobility, there is an ever-increasing number of entities that provide services. Mobility and transportation services may include traditional forms of public transportation (trains, light rail, subway, bus, ferry, etc.) and private transportation (taxi, shuttle, etc.), as well as newer forms of mobility services (bike sharing, scooter sharing, car sharing, e-hailing, etc.). Mobility as a Service (MaaS) may combine some or all of these different transport modes to offer a tailored mobility package, offering travelers more options when it comes to travel and payment. A managing authority is an organization and/or other entity that oversees transit usage by monitoring and/or overseeing operations of a number of public and/or private mobility services to achieve various policy objectives. The mobility services may be integrated into a single platform that enables travelers to access schedules and rates, plan journeys, and complete journeys using one or more of the mobility services. One or several managing authorities may operate in a given city/region and may provide services across multiple areas.

Embodiments of the invention(s) described herein are generally related to a platform that enables mobility service providers, mobility service aggregators, and/or public transportation providers to collaborate to provide mobility solutions to travelers. In particular, embodiments of the invention describe a Mobility as a Service (MaaS) Platform which serves a combination of the roles of orchestrator, integrator and operator of Mobility-as-a-Service and/or Mobility-on-Demand services). It will be appreciated that other terms may be used to describe the platform. For example, the platform may be called as Mobility-on-Demand (MoD) Platform. While described herein using the term “MaaS”, the concepts and claims are applicable for Mobility-on-Demand (MoD) applications as well. That said, a person of ordinary skill in the art will understand that alternative embodiments may vary from the embodiments discussed herein, and alternative applications may exist.

It will be understood, however, that the applications for the invention(s) are not so limited. Embodiments of the present invention

Embodiments of the present invention are directed to systems and methods that enable transit authorities and/or other operational entities (including municipalities) to monitor and control transit operations. In particular, embodiments may enable operational authorities to adjust various operational parameters to encourage users to utilize a particular route and/or transit service and/or discourage users from utilizing a particular route and/or transit service. For example, public policy reasons may dictate that user traffic needs to be dissipated in one or more areas, such as to reduce congestion (e.g., during rush hour, etc.), decrease pollution in a given area, to route traffic away from school areas, events, etc. Additionally, embodiments may help increase mass transit ridership, which may help ease congestion and reduce pollution.

Embodiments also provide software solutions for end-users that provide all-in-one interfaces that enable the end users to quickly and easily plan and complete journeys. The software solutions may be implemented as websites, standalone software, mobile applications, and/or in other forms. In some embodiments, end-users may use the software to plan and execute single and/or multi-modal journeys that involve the use of one or more forms of transportation (e.g., mass transit, rideshare, bikeshare, walking, etc.) to reach one or more destinations. The end-user may be able to plan, pay for, and provide ticketing information using a single mobile application, enabling the end-user to complete an entire journey using a single mobile device as a journey planning tool, payment media, and mobility service fare.

Entities that provide mobility services may be called Mobility Service Providers (MSPs). MSPs may include all public and/or private organizations, and may offer one or more modes of transportation. MSPs may provide services directly to travelers or via a MaaS operator, which may be a mobile application, website, and/or other software platform that enables the travelers to plan, book, and/or complete single and/or multi-modal journeys using one or more of the mobility service providers. A public transit agency or operator may be an example of a public MSP. One example of a private MSP may include a for-profit company providing direct or contracted services for travelers (e.g. using driver-operated vehicles, autonomous vehicles, or traveler self-driven vehicles). Examples of private MSPs may include companies providing rideshare, ridehail, scooter sharing, bike sharing, car rental, etc.

A “managing authority” may include an office, agency, or person responsible for regulation and or control of the mobility services in a given region. In many instances, the managing authority may also be a public MSP. For example, the managing authority may be a city transit agency, department of transportation, and/or regulatory authority.

Although managing authorities, MSPs, and MaaS operators (generically referred to herein as “mobility entities”) may work together to provide travelers mobility services, there are difficulties in doing so. Technical obstacles arise, for example, from the MaaS operator and MSP managing and operating their respective services with different systems. Because there is no industry-standard set of Application Programming Interfaces (APIs) that may allow these systems to more easily integrate, it may take months of customized integrations to enable such systems to work together effectively. Business obstacles may also arise, because mobility entities may have different standard contracts and/or business arrangements. Negotiating a commonly agreed-upon relationship may also take quite some time.

Embodiments of the invention(s) provided herein address these and other issues by providing a MaaS interface that allows members (e.g., different mobility entities) to find each other and connect—in both technical and business aspects—in an effective and efficient manner. In particular, the MaaS platform may enable each mobility entity to network portions of their computing systems/functionality using specific APIs, portals, and tools that are delivered through the MaaS platform (which may be open source and/or proprietary) to facilitate communications between entities to provide mobility services (reservations, journey planning, payment, status, etc.) in an agnostic way.

Embodiments may be considered “agnostic” in two ways. First, the MaaS platform may provide an open integration solution. That is, rather than requiring proprietary integration between the systems of two MaaS interface members (e.g., a MaaS operator and MSP), each member need only connect to the MaaS platform one time, which may serve as an intermediary to facilitate communication between the various entities. As an intermediary, not only may the MaaS platform help facilitate communication, but may also maintain a centralized ledger of interactions between the various connected entities. Interface members that connect with the MaaS platform may then quickly technically integrate with any other member that has also connected to the MaaS platform. For example, the MaaS platform may provide a single software interface that enables connected members to interact seamlessly with one another once connected to the MaaS platform. The MaaS platform may enable members to connect using a standard API. This allows each member to use the API to develop a software connection between their own platform and the MaaS platform, while eliminating the need for the different entities to program connections with APIs for each of the other entities they wish to integrate with. This saves considerable time and effort for the various entities. The MaaS platform API may ensure that each connected entity is able to provide any existing functionality and any necessary data in a desired format that is usable across the MaaS platform.

Second, the MaaS platform may enable its members to participate without the need of proprietary backend software. Members may instead interact with the MaaS platform via online portals and APIs, for example. Thus, there does not need to be any additional software outside the MaaS platform for mobility services to be effectively provided via the platform.

Advantages of bypassing proprietary integrations in this manner may be significant. As noted, the number (and type) of MSPs is significantly increasing. Even so, MaaS operators are often reluctant to expand the range and/or type of their services due to the difficulties and costs associated with integrating its existing system with that of an MSP. Traditionally, this process may take months, for example. However, by providing a MaaS platform with which members may quickly integrate, the embodiments provided herein may enable managing authorities the ability to expand the range of their services with relative ease. This may ultimately allow managing authorities to provide more services to their customers, mobility entities to more easily expand into new markets, and customers having more mobility options, thereby simplifying global integration for the various entities and making such integration more feasible without significantly increasing the time or resources needed by each entity. Additionally, any number of mobility service providers and/or other entities may provide journey planning services via the interface, which may enable the mobility service providers to facilitate multi-modal journeys, as the various provider systems may already be linked within the interface. This may help enable seamless journey planning and execution for end users, even when multi-modal journeys are taken.

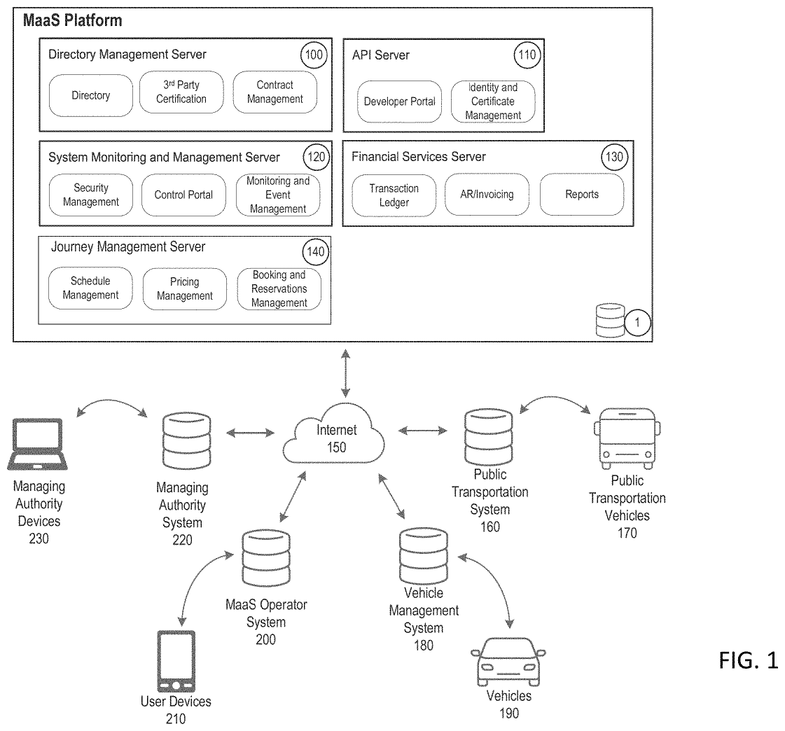

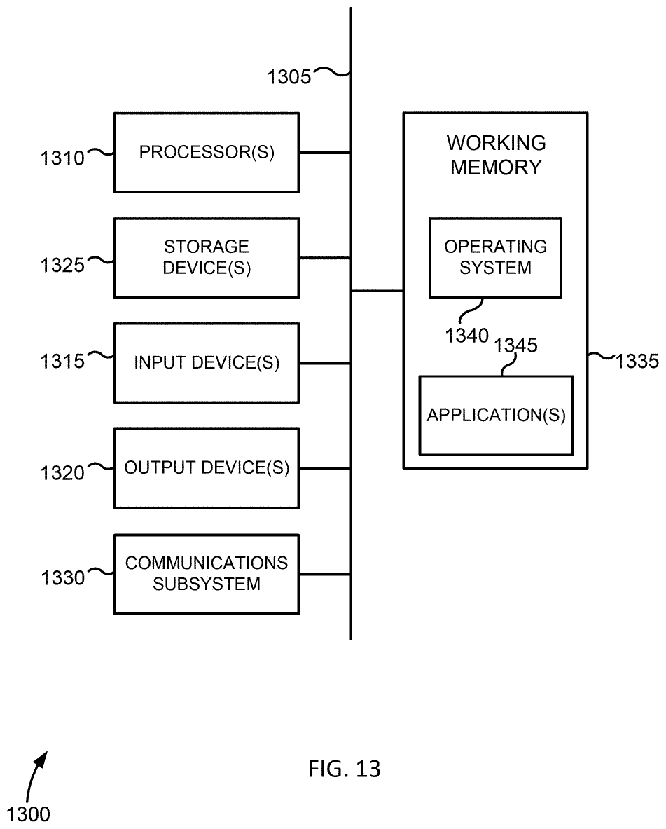

FIG. 1 is a block diagram of a MaaS system capable of providing users with a variety of mobility/transportation services, according to an embodiment. As with other figures provided herein, FIG. 1 is provided as a non-limiting example. Alternative embodiments may include additional and/or different types of mobility entities (managing authorities, MSPs, MaaS operators). Moreover, it will be understood that there may be any number of vehicles (e.g., public transportation vehicles 170, vehicles 190) or devices (user devices 210, managing authority devices 230) within the MaaS system. Further, the various “systems” shown (including the MaaS platform 1) may include any number of servers and databases utilized to provide the functionality of the corresponding system. Additionally, the various systems and devices shown may include or be integrated into a computing device, such as the computing device 1300 shown in FIG. 13. Additionally, the arrows in FIG. 1 show communication links between the various components. Depending on implementation, there may be any number of intervening devices, networks, etc. used to provide these communication links.

As noted, the MaaS platform 1 may enable members may quickly integrate and communicate with each other. As noted, these members may include any number or type of mobility entity. In the example provided in FIG. 1, a public MSP may operate the public transportation system 160 (with corresponding public transportation vehicles 170), a private MSP may operate a vehicle management system 180 (with corresponding vehicles 190, such as cars, shuttles, buses, cabs, etc.). A MaaS operator may operate the MaaS operator system 200, which may allow travelers to use user devices 210 for journey planning and ticketing for travel provided by MSPs connected to the MaaS interface 1. In some embodiments, for example, the MaaS operator system 200 may be used to support a software application, or “app,” executed on user devices 210. Additionally or alternatively, the MaaS operator system 200 may offer a web portal, allowing users to access to MaaS services via user devices 210 accessing the web portal.

Components maintained by managing authority may include a managing authority system 220 and/or managing authority devices 230. As noted, the managing authority may include a public transit system or operator. And thus, in some embodiments, the public transportation system 160 may be integrated with the managing authority system 220.

As shown, the MaaS platform 1 itself may include a variety of components and may be managed by a platform provider (not shown). Although shown in FIG. 1 as individual servers 100-140, the functionality provided by the MaaS platform 1 may be separated into different logical components and/or arranged in a different way. It may be further noted that these components may be executed by one or more computer systems (e.g. computer system 1300 illustrated in FIG. 13), which may be located at a single location or geographically dispersed (e.g., executed “in the cloud”).

The directory management server 100 may include a collection of software applications and modules configured to manage the membership of all members of the interface. This may include, for example, a directory that lists the various members, allowing members to discover and communicate with each other. Each entry in the directory may include the name of the member, the service(s) provided by the member, and performance. Performance for a particular member may include objective analytics regarding timeliness of mobility services, API performance, etc. This may enable another member to weigh these types of data when determining whether or not to enter into a relationship with the particular member.

The directory management server 100 may also perform third-party certification. According to some embodiments, the MaaS platform 1 may perform certification of members prior to allowing members to participate in the interface. The third-party certification may be performed by the directory management server 100, and may include various workflows that help ensure a member's integration into the MaaS platform 1 has been done properly, and the workflows of getting a member accepted into the system once integration is complete. Once certified, member may get promoted into the directory.

Additionally, the membership identity server 100 may perform contract management for the MaaS platform 1. Contract management may include obtaining and/or storing contracts to establish various business relationships. These contracts may enumerate the terms and conditions to establish a business relationship between members. As discussed in more detail below, members may be able to upload and use their own contracts. However, the MaaS platform 1 may additionally provide its own contracts for use by its members. In some embodiments, contract management may contain separate terms and conditions that prospective members need to agree to in order to participate in the MaaS platform 1 (e.g., a contract between a member and the MaaS platform provider).

The API server 110 may include a technical layer with which members may interact with the MaaS platform 1. Here, the API server may provide a developer portal (e.g., a web portal) that allows developers to login and access specification information for any number of APIs provided by the MaaS platform 1 that enable various functionality within the MaaS platform 1. For example, the APIs may enable journey planning, transaction management, contract management, data transfer, and/or other functionality within the MaaS platform 1. The API server 110 may further provide the APIs and further allow developers to test against the APIs as developers develop their own interfaces to interact with the APIs of the MaaS platform 1. For example, during a test an entity may be prompted to supply a particular data entry information in a particular format via the API. The test may return an indicator of whether the information provided was correct, which may enable the entity to self-certify that the entity system has successfully integrated the API specifications.

The API server 110 may further provide identity and certificate management, which may be used to securely authenticate a service into the MaaS platform 1. This may include, for example, maintaining and/or accessing member accounts for authentication.

The financial services server 130 may facilitate transactions between members of the MaaS platform 1. The financial services server 130 may provide a transaction ledger, for example, that creates and stores a record of transactions that flow through the MaaS platform 1. This may facilitate financial reconciliation and invoicing between members. It may also facilitate performance tracking of individual members.

As an example of information recorded by the transaction ledger with regard to an individual traveler's trip is as follows. The traveler may first pull up a travel application (on a user device 210) provided by a MaaS operator. Using the application, the traveler may select a trip using a particle mode of transportation (such as a scooter), provided by an MSP that provides scooter sharing. When the user selects the trip in the application, a ledger entry may be recorded showing the traveler's selection of the trip. The MSP may then respond by providing an estimated price, which may result in another ledger entry with the estimated price. If the traveler then chooses to book the trip, this confirmation may be reported as another transaction ledger. Additional entries may be made that record various events associated with the trip, including entries for unlocking the scooter, the scooter arriving at the trip's destination, locking the scooter at the destination, etc. The MaaS operator may further handle the payment by the traveler, which again may be recorded in the transaction ledger. Given this information in the ledger, the MSP that provided the scooter service may determine that the MaaS operator owes the MSP money for the trip taken and paid for by the traveler.

The financial services server 130 may further provide accounts receivable (AR)/invoicing and reports to various members. In the example above, for example, the MSP that provided the scooter service may interface with the financial services server 130 retrieve invoicing information, which may show the money owed to the MSP by the MaaS operator. The terms and conditions related to invoicing may be determined between the MSP and MaaS operator, and thus one or both members may interact with the financial services server 130 to obtain invoicing information and invoice/pay the other accordingly to reconcile the various payments. The financial services server 130 may further provide reports, enabling members to see transaction history and other financial and non-financial performance data. In some embodiments, the MaaS platform 1 may provide its members with various analytics of transactions based on data in the transaction ledger.

The journey management server 140 provides members an interface with the MaaS platform 1 to enable the planning and booking of travel. For example, the journey management server 140 may provide schedule management, with which MSPs may provide schedules for services. Such schedules may include predefined schedules (e.g., bus or train schedules), an Estimated Time of Arrival (ETA) for on-demand services (e.g., e-hailing/ridesharing or shuttle), estimated transit times for various modes of transit (including user-controlled options, such as walking, cycling, scootering, and/or other user-controlled modes of transport). As such, MSPs may upload predefined schedules to the journey management server 140 and/or interact with the journey management server 140 in real-time to enable the system 200, and subsequently user devices 210, to access real-time schedule information using the MaaS platform 1. The pricing management functionality of the journey management server 140 may enable the MaaS platform 1 to receive requests for providing pricing for a journey. This may include price estimation prior to booking the journey, as well as processing the payment for the journey once the journey is complete. Finally, the journey management server 140 may also allow for booking and reservations management for a journey.

As an example of how the journey management server 140 may be utilized during the booking of a journey, a traveler who may want to use a rideshare service for a journey logs onto a software application using the user device 210. The software application may act as a software client, which interacts with a server executed by the system 200. The system 200 may then access the journey management server 140 and use the schedule management functionality to determine an ETA for one or more rideshare vehicles 190 of an MSP providing a rideshare service. The journey management server 140 may send an inquiry to the vehicle management system 180 of the MSP to receive the ETA(s) in real time, in response to receiving a schedule management request from the system 200. Additionally, the MSP may provide an estimated price for the journey (along with the ETA(s)), which may also be provided by the vehicle management system 180 (or an associated system of the MSP (not shown in FIG. 1)). If the traveler chooses to book a journey using a vehicle 190 of the MSP via the software application on the user device 210, the user device may then send information indicative of the booking to the system 200 which may relay a request to book the trip using the bookings and reservations management functionality of the journey management server 140. The journey management server 140 may relay this information to the MSP to reserve the vehicle 190 and book the journey. The bookings and reservations management functionality of the journey management server 140 may also manage changes to the journey that may happen along the way (cancellation, changes in route, etc.), which may be initiated by the traveler using the user device 210 and/or MSP via the vehicle management system 180.

According to some embodiments, the functionality of the journey management server 140 may vary from this example. For example, in some instances and/or embodiments, the journey management server 140 may request ETAs and price estimations from multiple MSPs, which may provide mobility services of the same or different type. A traveler may be able to select this functionality using a user device 210 by, for example, selecting a user option to request journey estimates from multiple mobility service providers. This selection may be relayed to the journey management server 140, which may then send requests to multiple MSPs accordingly. The journey management server 140 may access any number of MSP systems when accessing journey planning services for a given journey. Additionally, in some embodiments, the journey itself may be a multi-modal journey that includes bookings with multiple MSP systems and/or multiple bookings with a single MSP system (such as two different shared rides for different legs of the journey).

Returning back to the MaaS platform 1, the system monitoring and management server 120 may provide the tools used by the MaaS platform provider to manage the MaaS platform 1. This may include, for example, security management tools, monitoring and event management, and a control portal. The control portal may a portal (e.g., web portal) through which the MaaS platform provider may access the various tools provided by the system monitoring and management server 120. Monitoring and event management tools may provide Information Technology (IT)-level management of a API services and other services provided by the MaaS platform 1, to help ensure the services are running properly. Security management may include audit and monitoring tools, for example, to be able to review the transaction ledger (and/or other data sources) for fraud, disable a member of the MaaS platform 1 if inappropriate activity is detected, and so forth. For example, if usage of the MaaS v 1 is uncharacteristically high the member may be rate-limited or disabled until an audit is performed.

As noted above, embodiments of the invention include networked systems that connect any number of private mobility service providers 180 (such as rideshare programs, bikeshare programs, and the like), public mobility service providers 160 (such as buses, trains, etc.), municipalities, and/or transit authorities, and end-users to provide journey planning and execution services, as well as that enable the municipalities and/or transit authorities to achieve desired policy objectives. The connections between the various entities may be achieved using APIs that enable data to be exchanged between the entities, which allows the end-users to plan and execute journeys that leverage the services provided by one or more public and/or private mobility service providers, while also enabling the municipality or transit authority to establish and pass policy restrictions to the various mobility service providers. For example, the MaaS platform may have its own API that be used by each partner (e.g., mobility service providers, etc.) to interface external computer systems with the MaaS platform system.

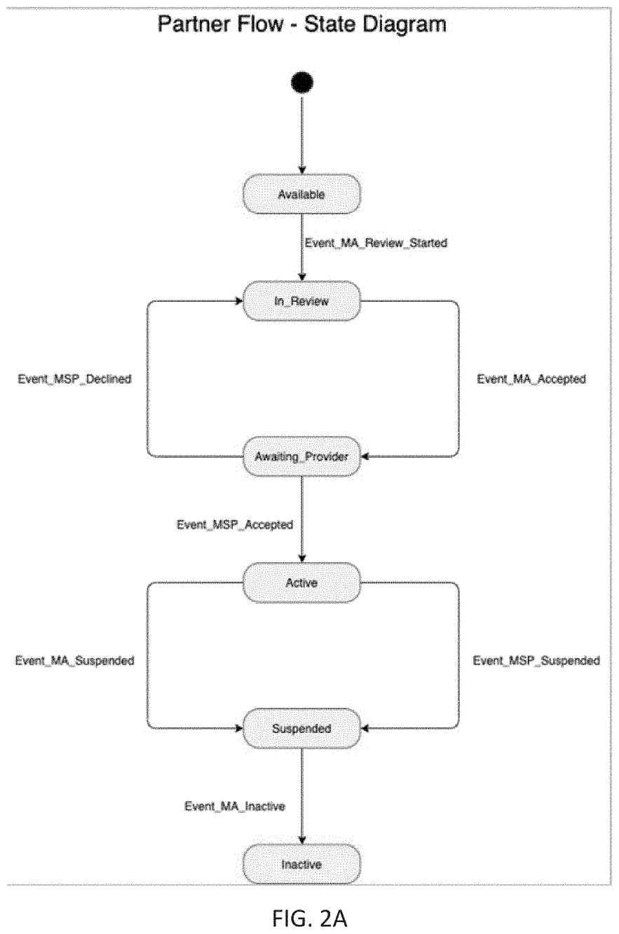

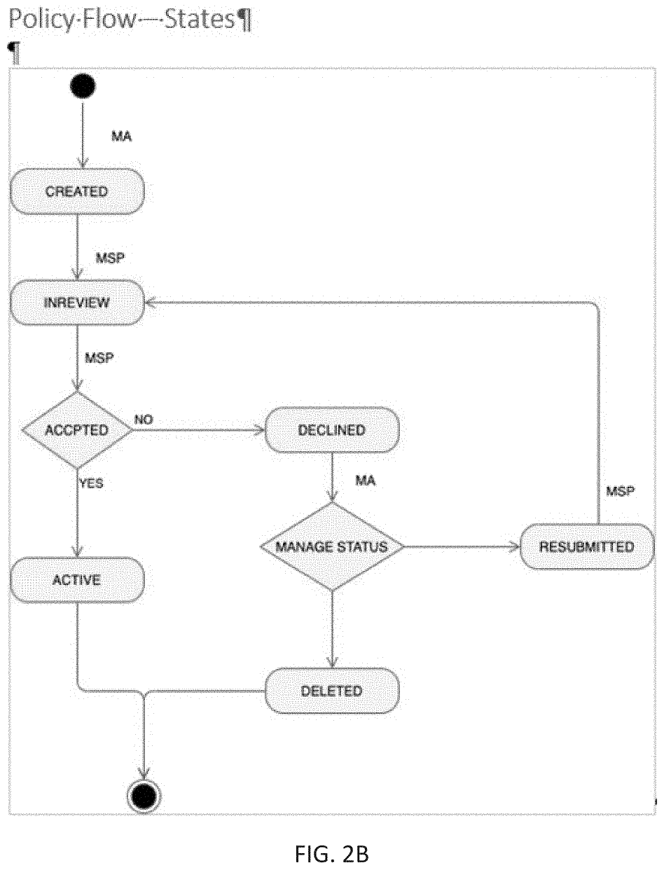

Public and/or private mobility service providers may be connected to a central MaaS platform 1 (which may be managed by the municipality, transit operator, and/or other entity). In some embodiments, each mobility service provider 160, 180 may go through an approval process (shown in FIG. 2A) that ensures that the mobility service provider meets a number of requirements of the MaaS platform 1 and agrees to operate in accordance with any policy restrictions set by the MaaS platform 1. Upon approval, the mobility service provider may be put into an active state in which end-users can view, book, and utilize transit options offered by the mobility service provider. The managing authority may also have the ability to suspend and/or disable operation of the mobility service providers, such as in the event of a breach of terms and/or for policy reasons.

As indicated above, the managing authority may create and implement policy restrictions that may limit an operation time, a geographic area, and/or other operation parameter of one or more mobility service providers to achieve policy goals. Such policy restrictions may follow an approval process as shown in FIG. 2B. The managing authority may create a policy restriction based on one or more policy goals (reducing congestion, reducing pollution, diverting traffic to/from an area, etc.). The policy restriction may be reviewed by each mobility service provider, which may accept or decline the policy restriction. If accepted, the mobility service provider agrees to abide by any restrictions imposed. If declined, the managing authority may delete the policy restriction, enforce the policy restriction and adjust a status of the declining mobility service provider (such as suspending the mobility service provider), and/or resubmit an altered policy restriction for review by the mobility service provider. The policy restrictions created may be sent periodically to a mobile application, website, and/or other software platform that facilitates journey planning for riders. The application may use these restrictions to exclude or filter the mobility service providers from appearing in journey search results if policy restricts their use based on time of journey or geographic location of the journey.

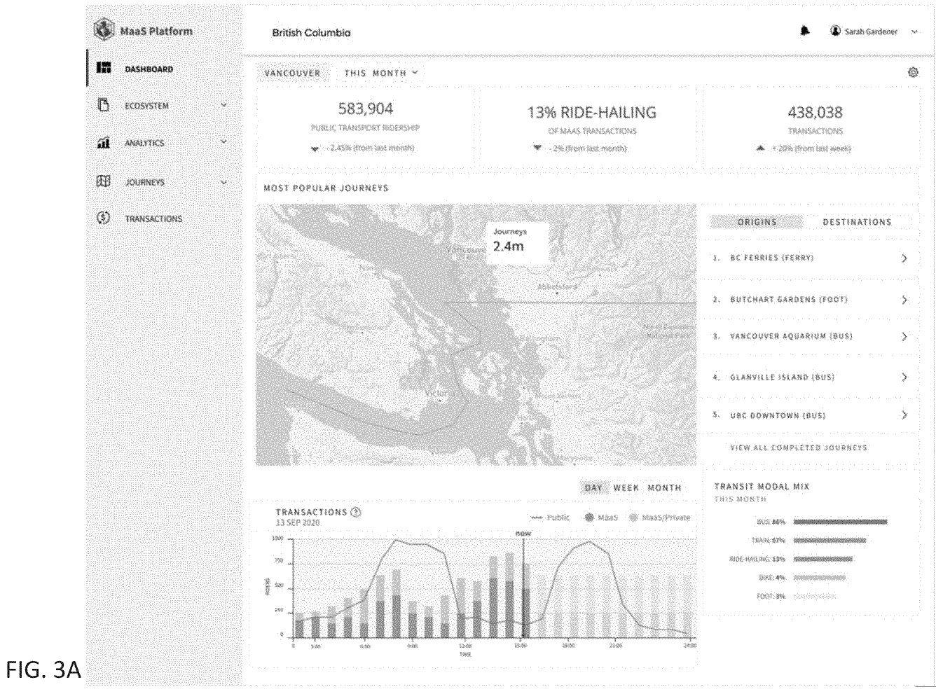

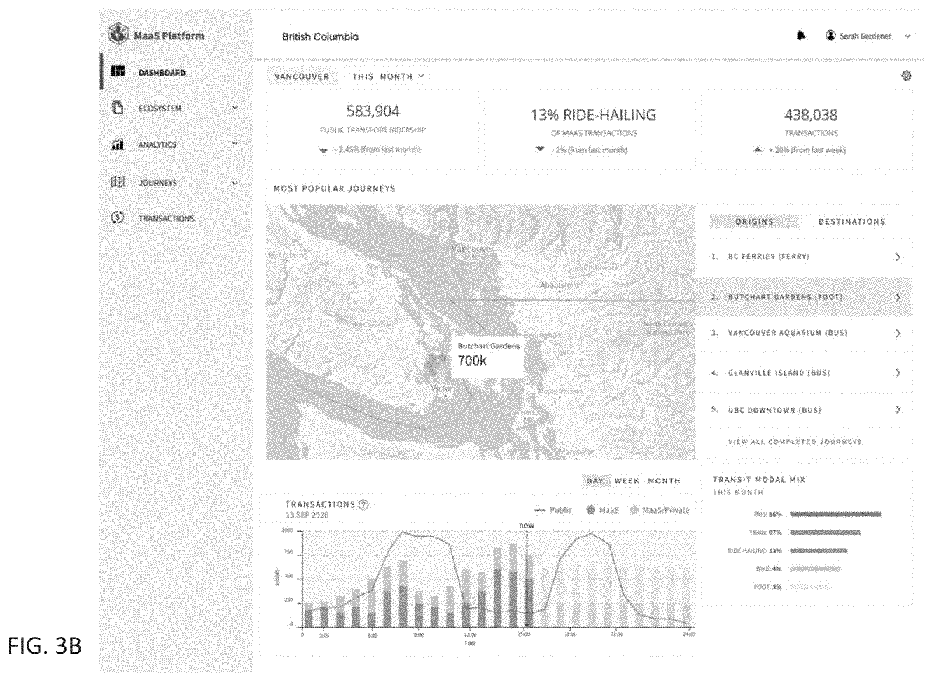

FIGS. 3A and 3B illustrate one embodiment of a dashboard utilized by a managing authority to view various metrics of one or more mobility service providers. Each dashboard described herein may be generated by the MaaS platform 1 and may be presented on a display device, such as a managing authority computing device. The metrics may include, but are not limited to, public transit ridership statistics (which may include data associated with trends and/or changes in usage/ridership across a given time period), ridesharing/bikesharing/taxi, etc. usage statistics for one or more of the mobility service providers, total number of transactions completed, original information, destination information, volumes of transit usage by transit type, and/or other metrics. The managing authority may select any number of metrics associated with one or more mobility service providers, and may be able to customize a desired date range, origin, destination, trip duration, trip distance, combination of transit types, and/or other criteria that enable the managing authority to analyze usage of transit services throughout a given area. The metrics may be viewed for a single mobility service provider and/or a number of mobility service providers concurrently on the dashboard, which may facilitate comparisons between the usage of different mobility service providers. This may enable the managing authority to better determine what policy restrictions should be implements to achieve various policy objectives. For example, a MaaS operator may be able to view usage statistics with a number of mobility service providers to determine which providers get the most usage, are most efficient, least efficient, contribute to higher/lower mass transit ridership, and/or make other determinations that may be useful in determining how to best achieve a desired policy objective. For example, if a particular subset of mobility service providers contribute to lower mass transit ridership, the MaaS operator may implement a restriction on the usage of such mobility service providers within a given area to reduce congestion, reduce pollution, and/or aid another policy objective.

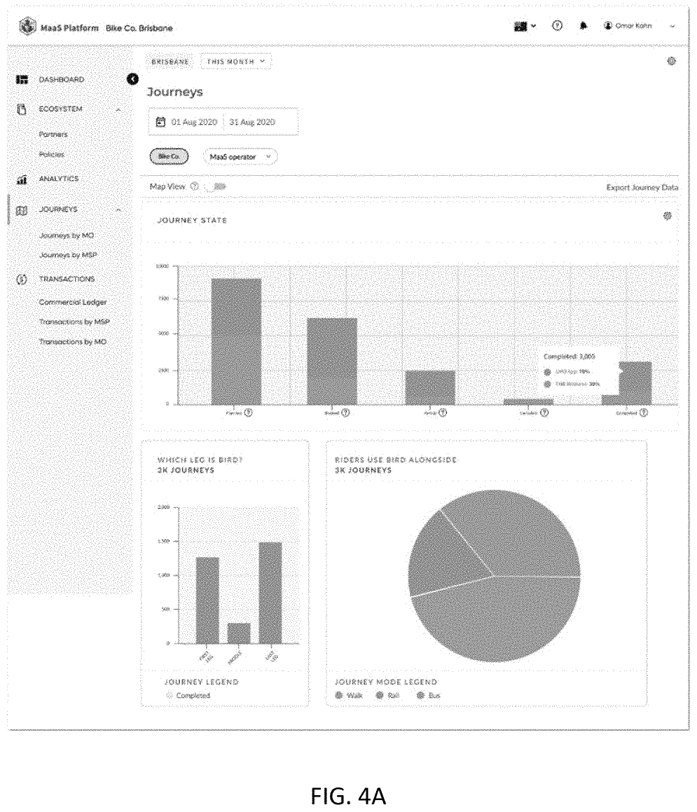

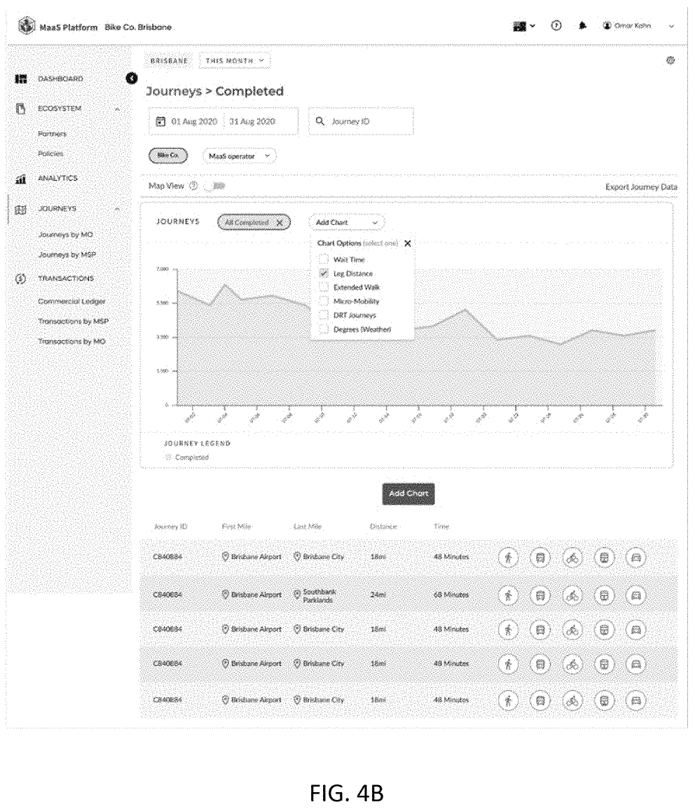

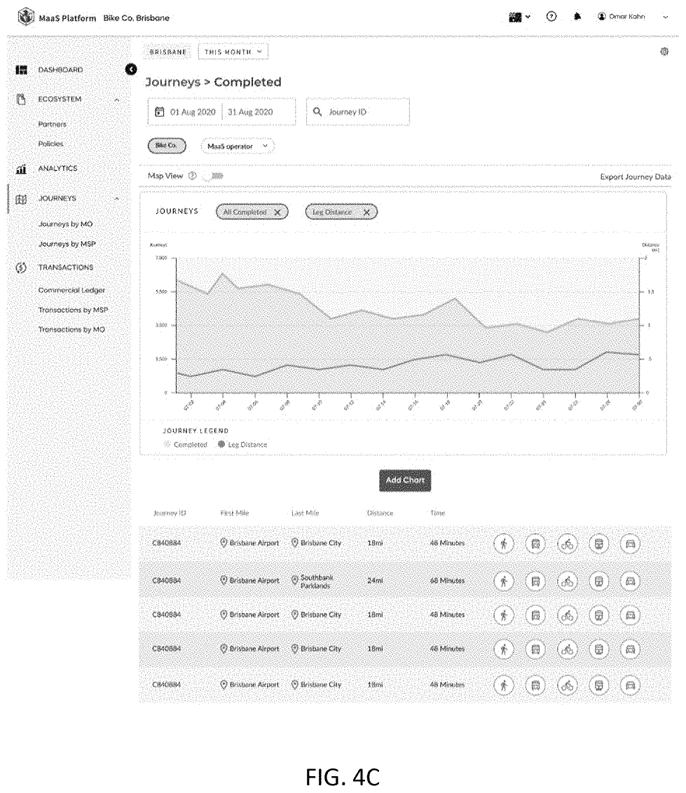

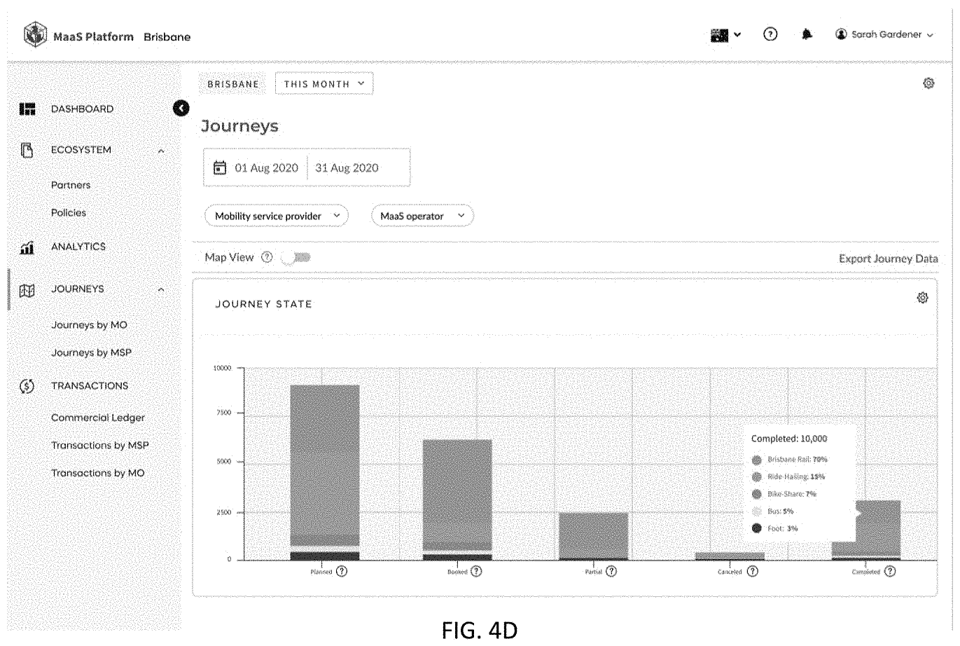

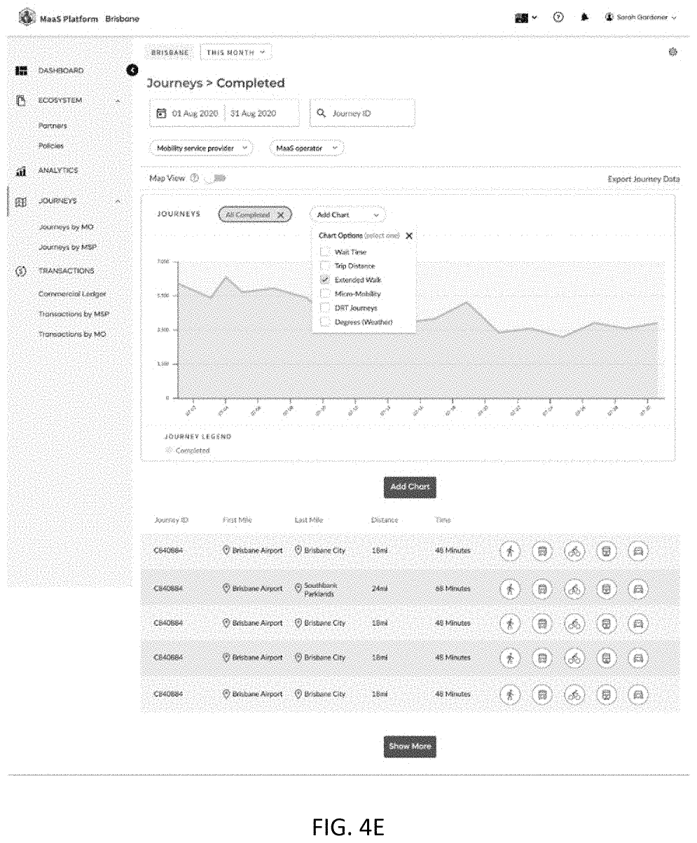

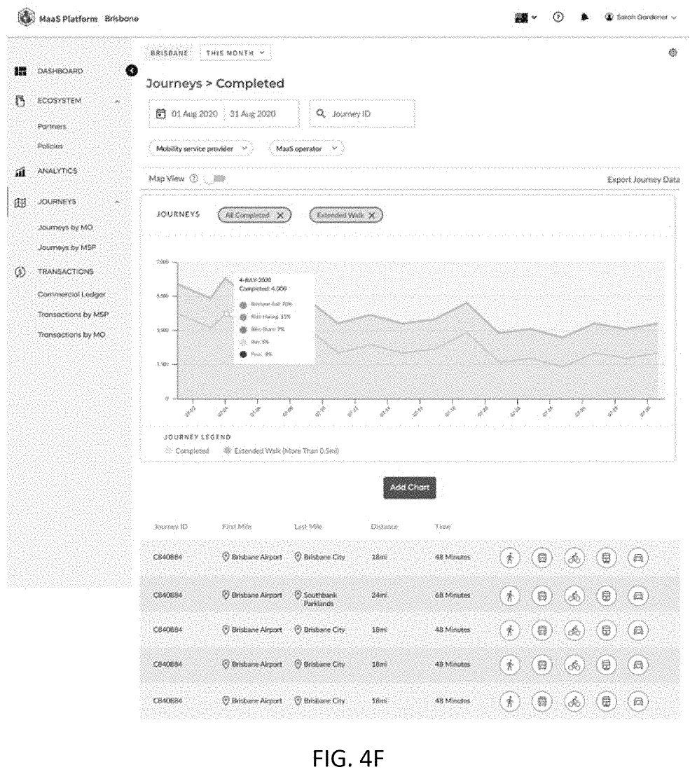

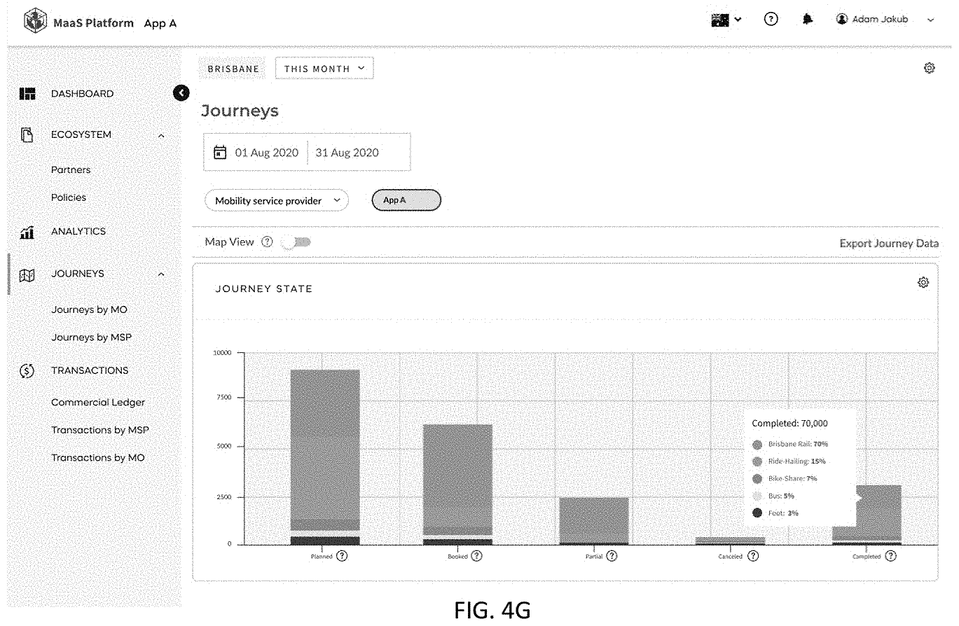

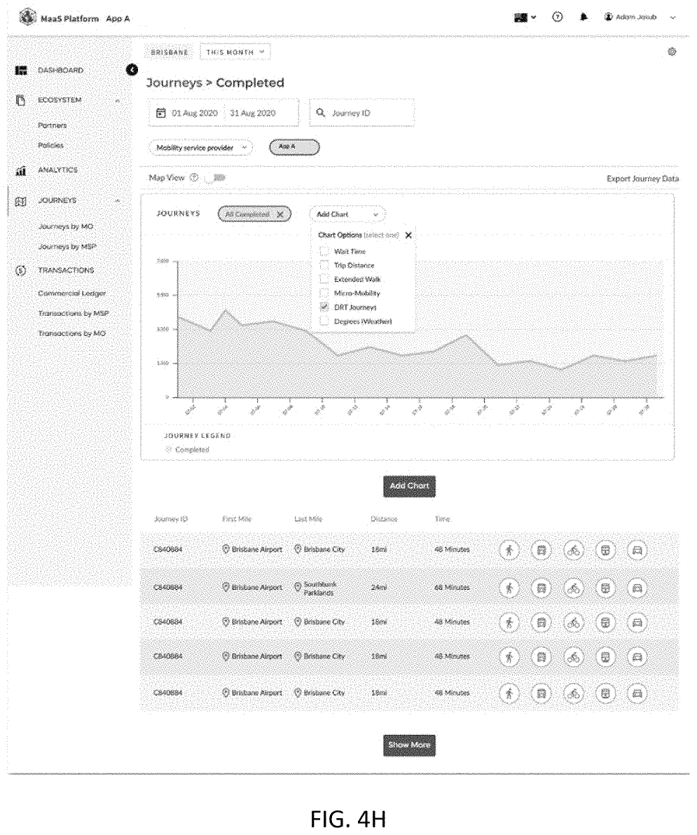

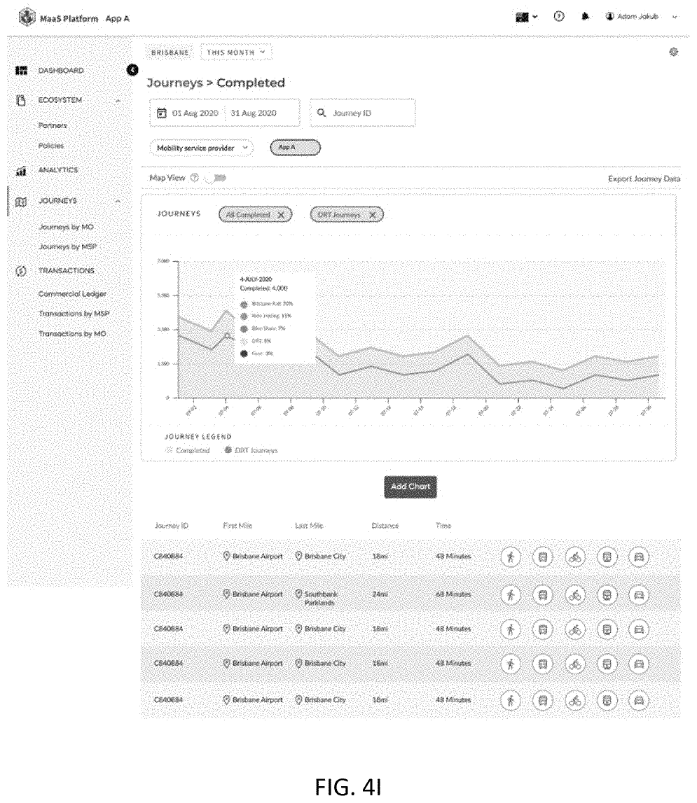

FIGS. 4A-4I illustrate a journeys interface that enables the managing authority to view various metrics about journeys, such as a number of journeys that have been planned, booked, partially complete, canceled, and/or fully completed. The journeys interface may enable the managing authority to break down all or a subset of the journeys and in some embodiments, may be broken down by mobility service provider and/or mode of transportation (including walking or other free transportation means), as well as provide statistics on when one or more types of transportation or mobility service providers are used. For example, metrics showing which leg of a journey are most likely to involve walking or bikeshare/scooter-share programs may be viewed. The journeys interface may show all journeys, or just those associated with a certain type of transportation and/or mobility service provider. Metrics may also include a duration of each leg of a journey, a distance of the journey, origin/destination information, etc. The managing authority may select options to produce customized numerical data and/or graphs detailing specific combinations of metrics. The metrics may include actual values, averages, shortest, longest, and/or other statistical representations of a given metric, which may be over a given time period.

The journeys interface may include one or more sections or screens. For example., as illustrated in FIG. 4A, one section may provide metrics associated with journey states (e.g., planned, booked, partially complete, canceled, completed, etc.) for journeys associated with one or more mobility service providers. The section may also include an indication of which leg of multimodal journeys each selected mobility service provider is utilized. For example, as shown, a graph may be provided that illustrates which legs of multimodal journeys are most associated with a given mobility service provider. The section may also include an indication of which other types of transportation and/or mobility service providers are used in conjunction with the given mobility service provider. For example, as illustrated, the section may include a graph that provides a breakdown of a number or percentage of each transportation type and/or mobility service provider used alongside a given mobility service provider in multimodal journeys. The breakdown may indicate which transportation types and/or mobility service providers are most likely to be used together in a single journey.

FIG. 4B illustrates a section of the journeys dashboard that provides data associated with the average and/or absolute distance and/or average and/or absolute duration of trips completed using one or more selected mobility service providers. For example, as illustrated, one or more charts may be provided that enable the managing authority to visualize distance and/or duration information for a given time period. Additional information may be provided as well, such as, but not limited to, a wait time for the selected mobility service providers, a leg distance, information about extended walks to or from the mobility service provider, micro-mobility legs, demand responsive transport information, weather during a given journey and/or time period, and/or other information. The chart may enable a user to select which data is to be displayed. Additionally, the section may include a table of the information that is used to populate the chart, which may enable the user to get more detailed information about a given data point, journey, and/or mobility service provider. Each data set may be further broken down by journey state. The various charts may be displayed one at a time, side by side, overlaid atop one another, and/or otherwise simultaneously displayed.

While shown on different sections, it will be appreciated that in various embodiments any of the information described above and/or other information may be combined in any other manner to meet the needs of a particular application. In other words, the illustrated sections are merely provided as examples, and the information from different sections may be combined and/or separated.

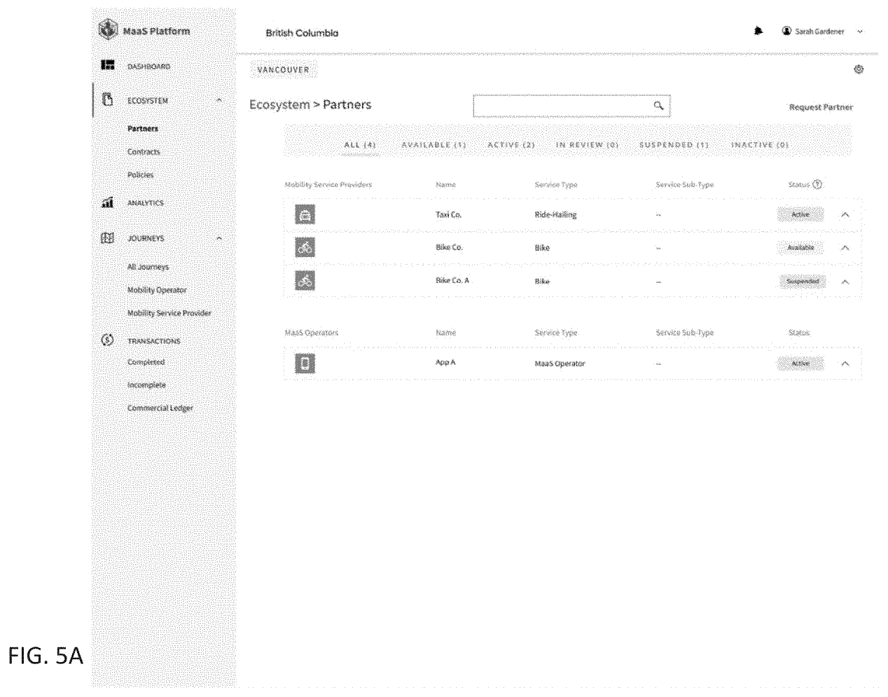

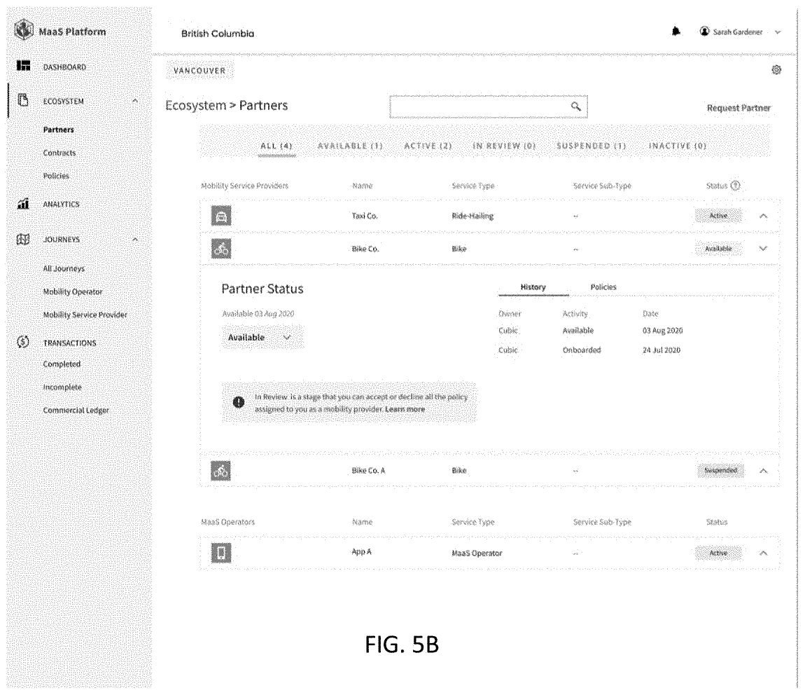

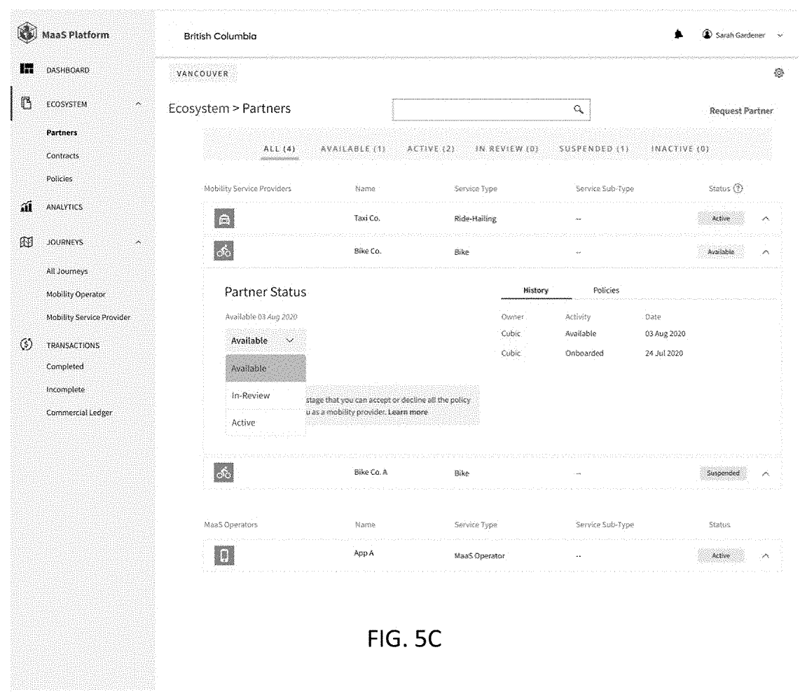

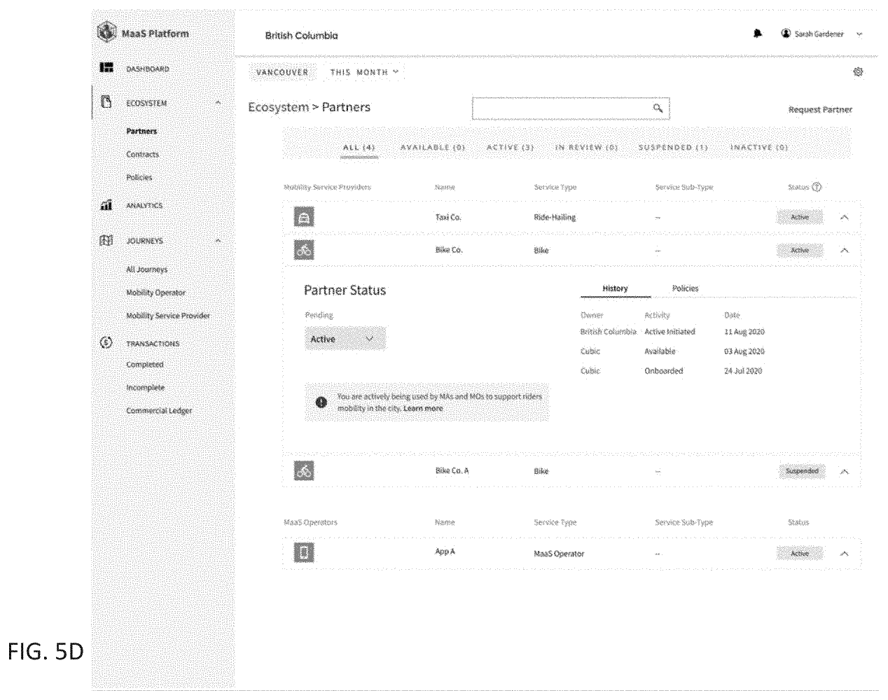

FIGS. 5A-5D illustrate a partners dashboard that enables the managing authority to view and adjust the status of one or more partners, such as mobility service providers. The managing authority may view all partners at once, or sort the partners by location, status, partner type (private mobility service provider, public mobility service provider, bus, train, rideshare, bikeshare, etc.), sub-type, and/or other category. The managing authority may be able to see a name of each partner, a service type/category, service sub-type, status, and/or other information associated with each identified partner. As illustrated in FIG. 5A, the managing authority may be able to set the status of each partner, such as active (e.g., allowed to operate), in review (e.g., a stage in which the mobility service provider may accept or decline all policies assigned to the mobility service provider), available, suspended, and/or other status. As illustrated in FIG. 5B, the partners dashboard may also provide history information for one or more of the partners, such as an onboard/initialization date, status change information, etc. The partners dashboard may also display a history of current and/or past policy restrictions associated with each partner and/or location, and in some embodiments may indicate whether the partner cooperated with the policy restriction.

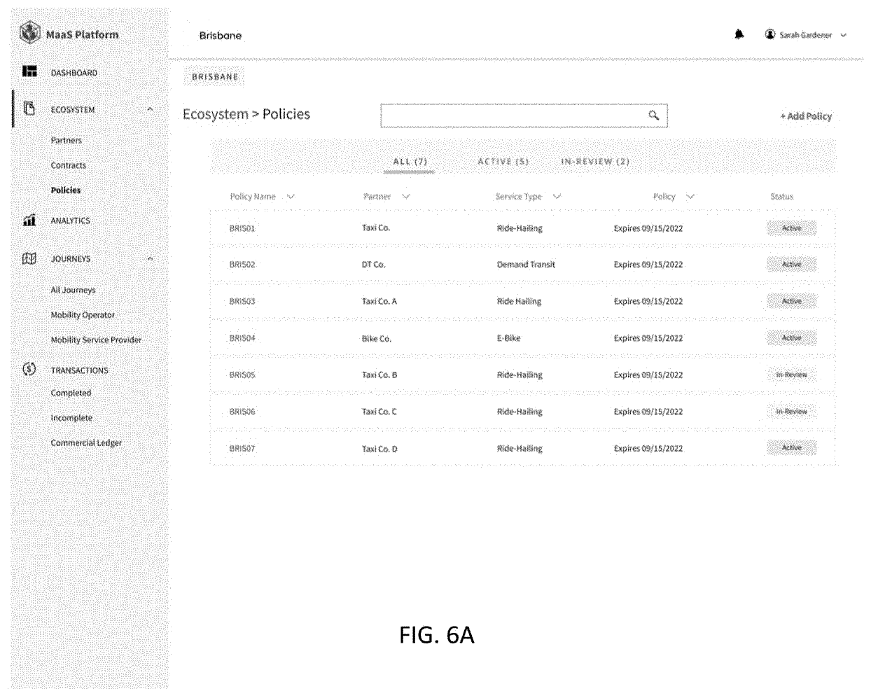

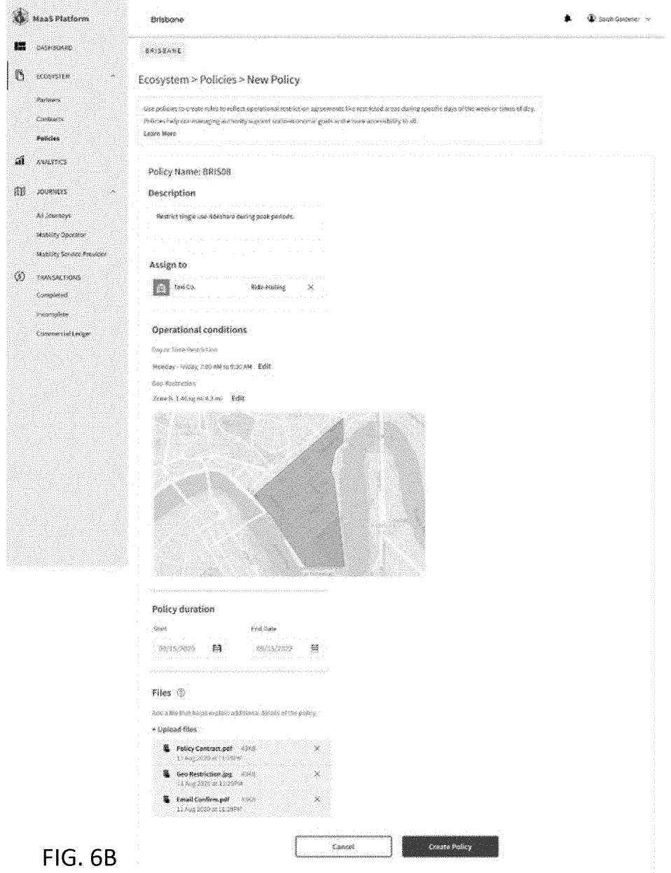

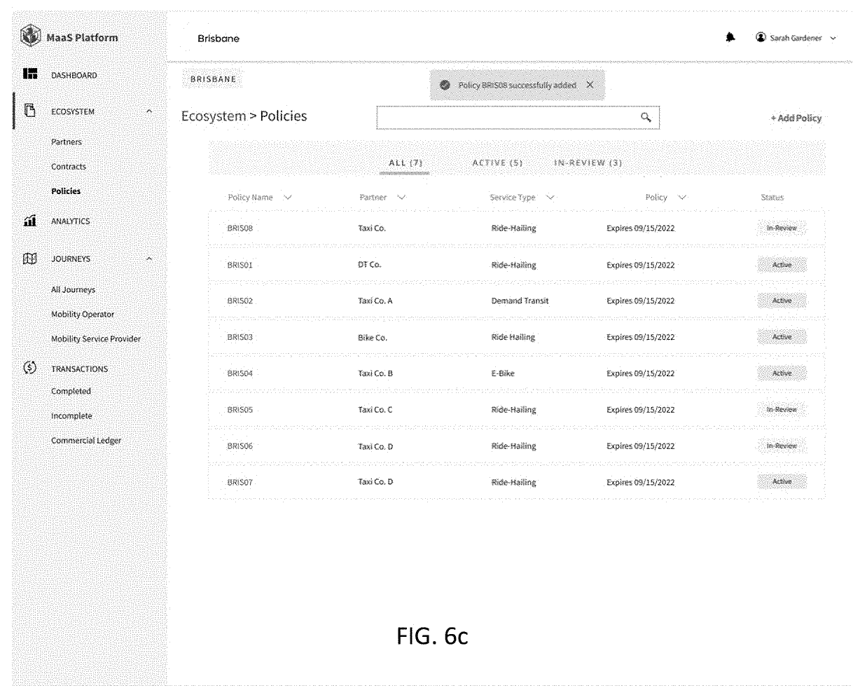

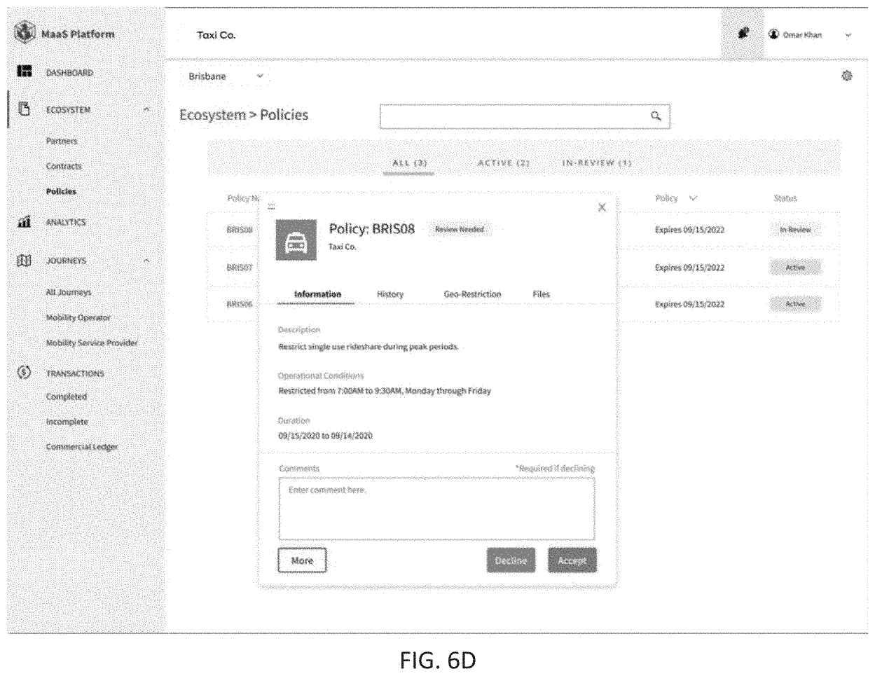

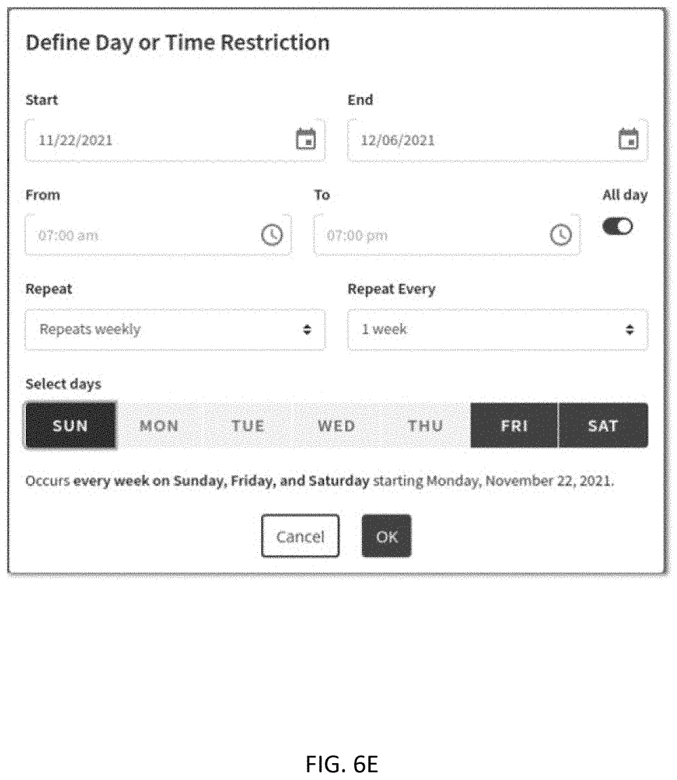

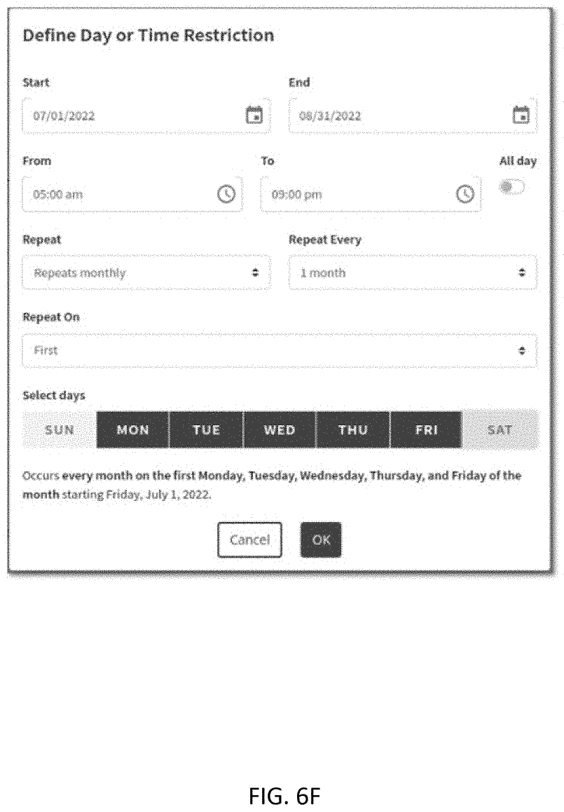

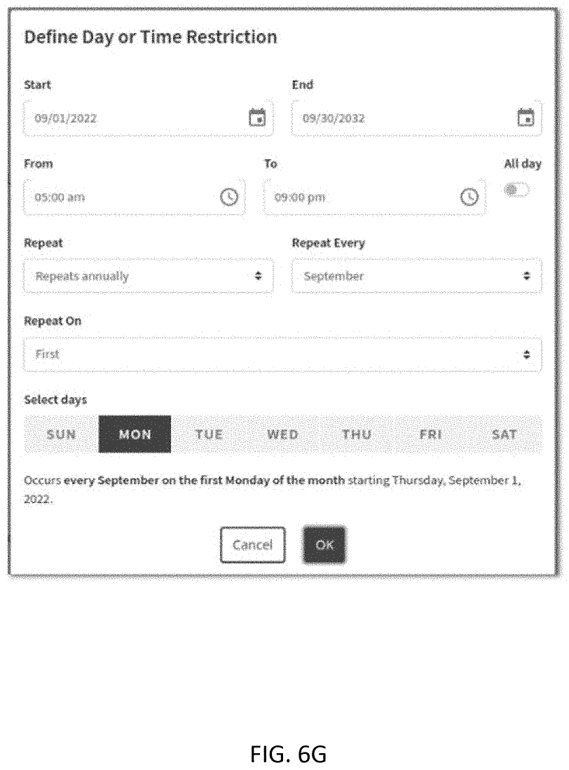

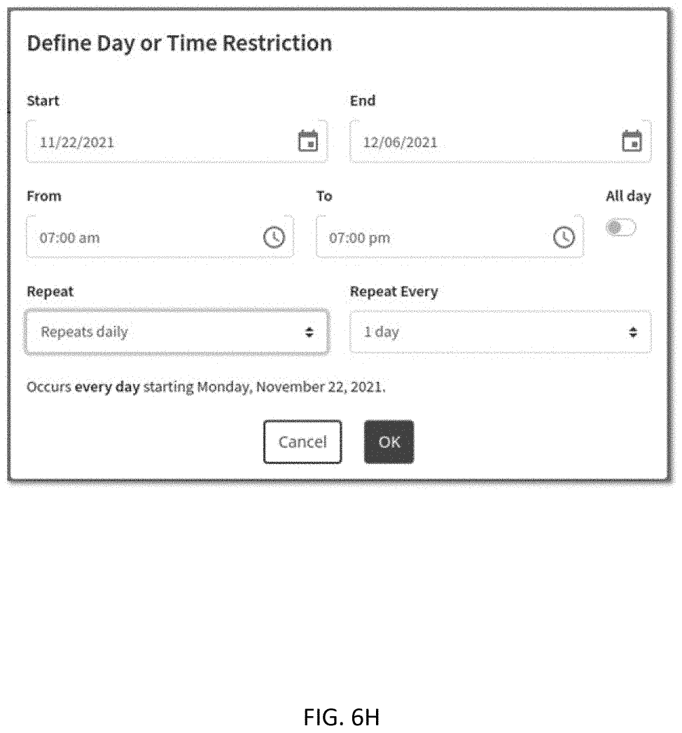

FIGS. 6A-6I illustrate a policy dashboard that enables the managing authority to view current and/or past policy restrictions, as well as setup new policy restrictions. As illustrated in FIG. 6A, each policy restriction may include a policy name or other identifier, one or more associated partners/mobility service providers, associated service types, effective time periods, statuses, and/or other information. FIG. 6B illustrates a portion of the policy dashboard that may be utilized to create and implement new policies for one or more mobility service providers. The policies may be used to implement rules that impose operational restrictions that limit the operation in certain locations, for specific time periods (such as times of day and/or days of the week) to achieve various policy objectives. To create a policy, a policy name or other identifier may be assigned by a user and/or automatically by the MaaS platform 1. The user may enter a description of the policy. For example, the user may summarize the policy, such as restricting single use rideshares during peak traffic periods. The user may then assign the policy to one or more mobility service providers and/or provider types (e.g., rideshares, ride-hailing, user-operated vehicles such as scooters and bikes, etc.). The user may then input a number of operational conditions of the policy. For example, the user may input a day and/or time restriction in which the policy with take effect. The time restriction may include one or more time ranges, which may all or part of one or more days. The policy duration may be set for a single instance, or may be a recurring policy for the given time restriction (such as Monday-Friday between 7 am and 9:30 am). Each policy may be associated with a particular geographic area. For example, the geographic area may be set by a user as a radius around one or more points of interest, may be drawn in or otherwise inputted as a custom geofenced area, a particular route and/or set of one or more roadways, and/or otherwise input into the policy dashboard. The policy restriction may include an active time period, such as a start and/or end date for the policy restriction. The policy restriction may include one or more usage restrictions. As just one example, a policy restriction may indicate that single user rideshares are limited or banned within a certain geographic area during peak periods. The managing authority may create the policy restrictions that include all necessary information, and select one or more partners who are to be subject to the restrictions. The selected partners may be sent a policy contract, information associated with the policy restriction (such as area, the restriction terms, restriction duration, etc.), and/or other related information. Once a policy has been created, the policy may be included in a log of policies as shown in FIG. 6C. The log may be filtered to show only current policies, all policies, expired and/or otherwise inactive policies, policies in a given location, policies for a given time period, policies affecting a particular subset of mobility service providers and/or transit types, and/or other categories of policies. As shown in FIG. 6D, users may select a given policy to view, accept, reject, adjust, and/or interact with the policy. For example, the managing authority may view the policy to see the details, adjust the policy, and the like. Each mobility service provider may view the policies affecting that particular mobility service provider to accept or reject the restriction. If the policy is rejected, the mobility service provider may be suspended from service within the MaaS platform 1 in some embodiments, although other actions may be performed in various embodiments.

As shown in FIGS. 6E-6H, the managing authority may set the time restriction of each policy. For example, the managing authority may set a start and/or end date for the policy as shown in FIG. 6E. The start and end date may be the same date, or may extend over multiple days, weeks, months, years, perpetuity, etc. The managing authority may be able to select a time period for when the policy is to be active as shown in FIG. 6F. The time period may be within a single day and/or may span multiple days. In some embodiments, multiple time periods may be set within a single day. For example, a single policy may be set to restrict single occupancy rideshare during both a morning and an evening rush hour, while permitting such rideshares in between the rush hour periods. The managing authority may be able to set whether the policy should be a single instance (such as for an event) or may be recurring. If the policy is to be recurring, the managing authority may select a frequency of repeat occurrences of the policy (e.g., daily, weekly, monthly, etc.), as well as designate a date, day of the week, and/or other starting point for the repeating as shown in FIGS. 6G and 6H. The managing authority may also select which days of the week the policy may be active. In some embodiments, the policy dashboard may provide a summary of the time restrictions input so that the managing authority can quickly review the various time inputs.

Once a policy is created and/or activated, the journey planning and/or booking interfaces and services may receive an indication of the policy such that any mobility service providers whose operation is restricted by the policy are dynamically disabled from the journey option during the selected day(s), time(s), and/or area(s) to ensure that travelers are not able to book travel using such inactive and/or otherwise unavailable mobility service providers during the active periods of the policy. The journey planning and/or booking interfaces and services may then dynamically re-activate the affected mobility service providers one the restrictions associated with the policy are over and/or otherwise inactive. Geo-restriction based policies can block mobility service providers from operating in certain area(s) defined by one or more polygon, radii, and/or other shapes.

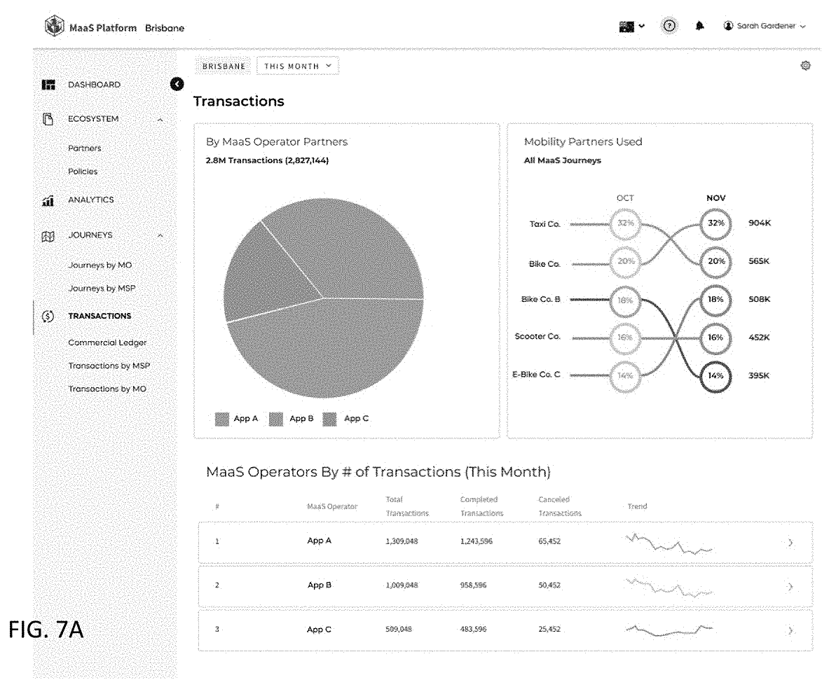

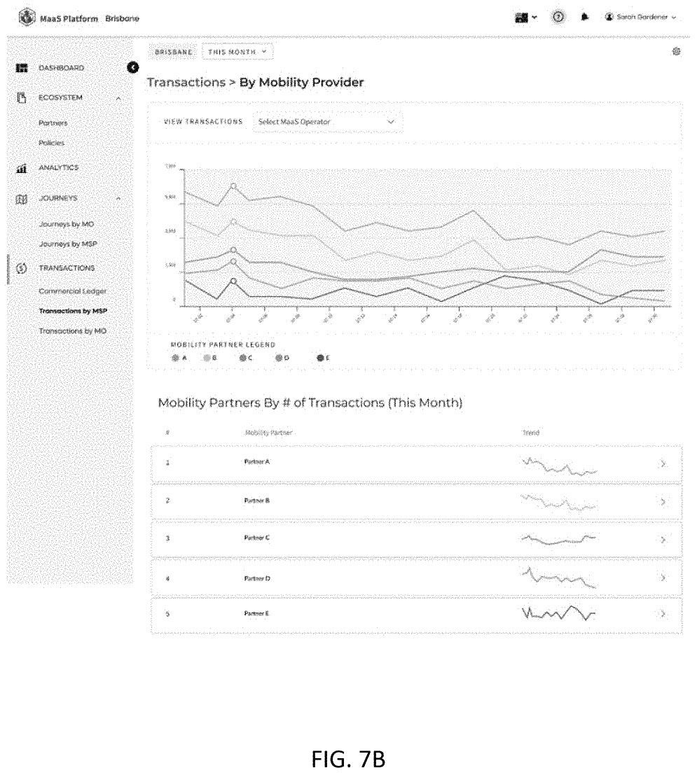

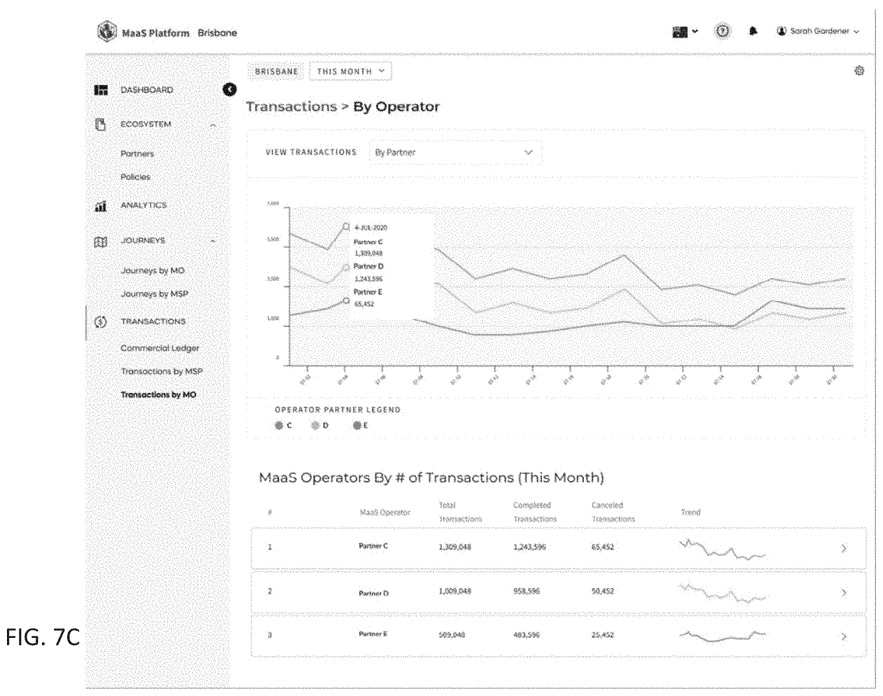

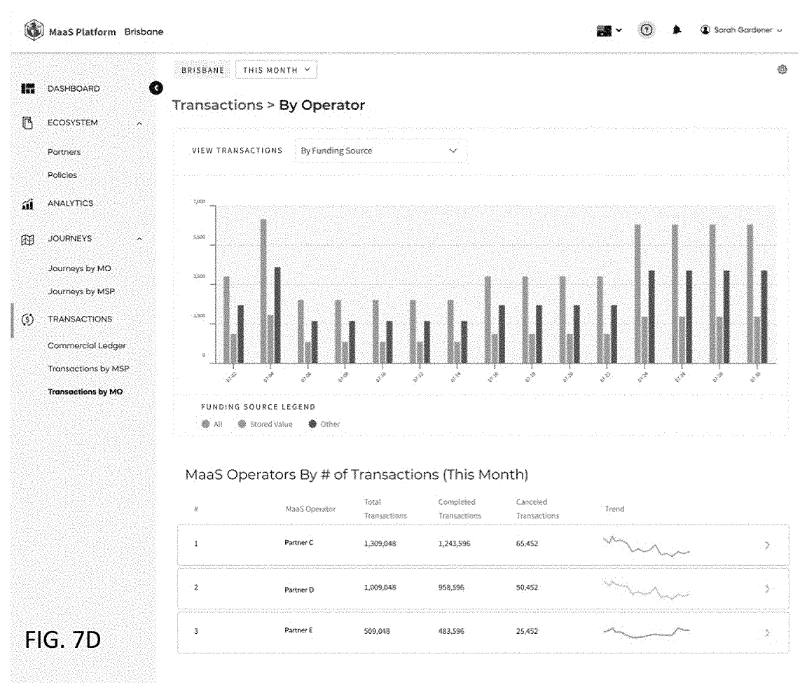

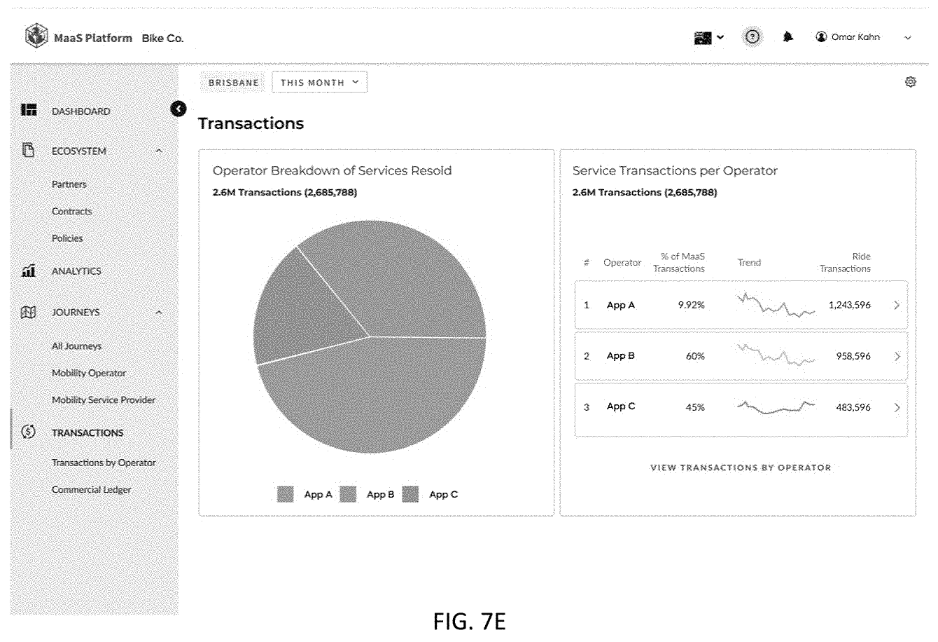

FIGS. 7A-7E illustrate an embodiment of a transactions dashboard that enables the managing authority to view metrics related to transactions of partners within one or more geographic areas and/or origin/destinations. The transactions dashboard may enable data and/or graphs to be customized based on total transactions, transactions by date range, transactions by partner/mobility service provider, transactions by service type, transactions by booking method, canceled transactions, booked transactions, completed transactions, transactions by funding source, and/or other information. The information may be presented in terms of numbers of transactions, percentages of transactions, and/or other metric. For example, as illustrated in FIG. 7A, the dashboard may include a graph and/or table that breaks down how many transactions each mobility service provider was involved in over a given period of time. A chart may be included that demonstrates changes in ridership/usage for some or all of the mobility service providers from one time period to another. For example, the dashboard may include a chart that shows several mobility service providers, with ridership/usage ranked over a number of time periods. As illustrated in FIG. 7B, the dashboard may include a graph and/or table that shows usage/transaction trends over time for one or more of the mobility service providers. The graphs may include line graphs, pie charts, bar graphs, and/or other types of graphs as shown in FIGS. 7A-7E. In some embodiments, the graph may be interactive, such that a user may hover over, click on, and/or otherwise interact with a data point or set of data points to view more detailed information associated with the selection. The data table may include an identifier of each mobility service provider, a number of total transactions, a number of completed transactions, a number of canceled transactions, a trend of transactions for each mobility service provider, and/or other data that is included and/or associated with the graphs.

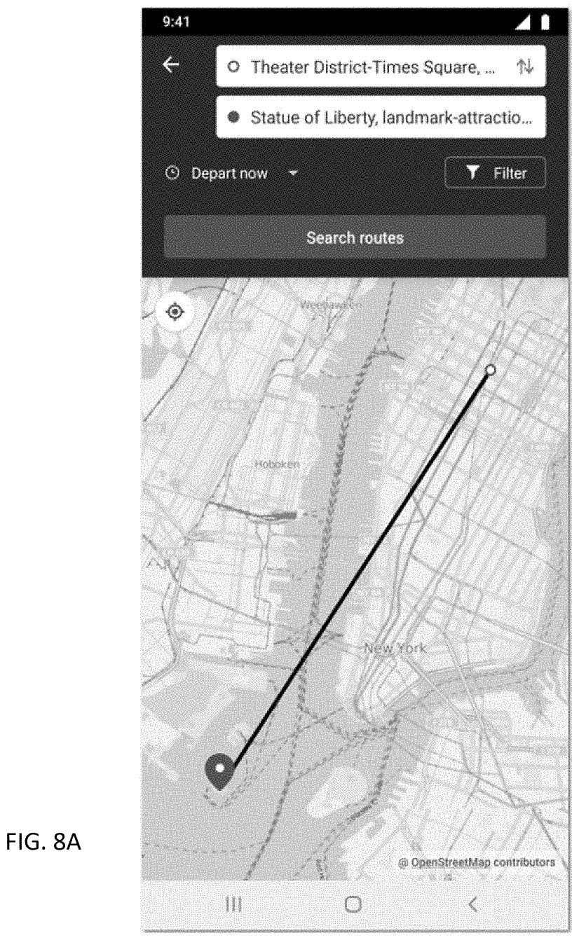

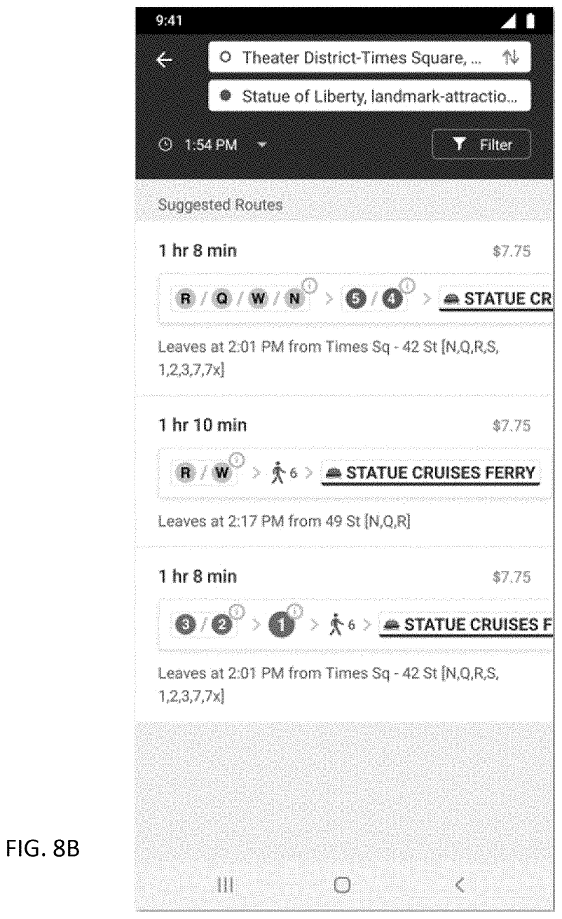

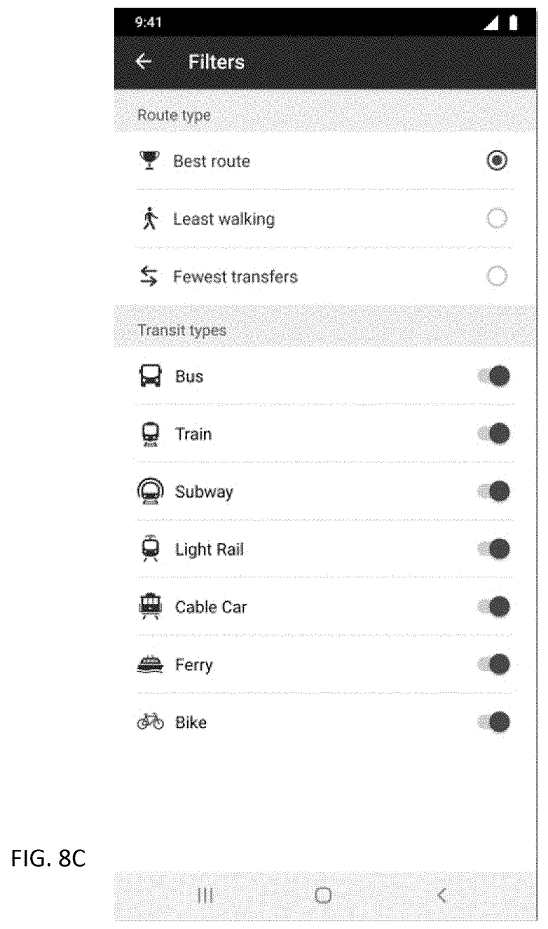

FIGS. 8A-8C illustrate a journey planning interface according to some embodiments. Each interface described herein may be generated by a website, mobile application, and/or other software platform that may be executed on a user device such that the interface may be presented on a display device, such as a user device. The platforms may be interfaced with the MaaS platform 1 to ensure that the user may seamlessly interaction with journey planning, booking, and execution services of a number of different mobility service providers using a single platform. The journey planning interface may be displayed on a website, mobile application, and/or other software platform (e.g., MaaS operator) executed by an end-user device, such as a personal computing device and/or mobile device. The journey planning interface may enable an end-user to select an origin, one or more intermediate and/or final destinations, departure times, arrival times, preferred modes of transit, preferred cost options, and/or other information. The journey planning interface may provide the end-user with one or more trip options, which may specify a trip duration, one or more modes of transportation, departure times, arrival times, journey costs, types of modes of transport, number of transit transfers, and/or other information that may be useful to the end-user in selecting a journey. The journey planning interface may allow the journey options to be filtered and/or sorted by any number of factors such as, but not limited to, a best route, least walking, fewest transfers, cheapest route, quickest route, shortest distance, earliest departure, earliest arrival, mode of transit, etc. For example, as illustrated in FIG. 8A, the journey planning interface may enable a user to input information, such as an origin, one or more intermediate and/or final destinations, departure times, arrival times, etc. to receive information about available routes/mobility service provider options based on the user inputs. For example, upon receiving information from the traveler, a journey planning service may query map and traffic services, mass transit operators, the mobility service provider systems, and/or other database to retrieve schedules, traffic information, routes, available vehicles, fare costs, etc. to identify what transportation options are available that meet or closely meet (e.g., within predetermined parameters, such as within a predetermined number of minutes and/or distance) the traveler's information. As indicated above, the transit options may take into account any policy restrictions that are in effect during the traveler's proposed time to ensure that the traveler cannot book a transit option that will not be available due to such restrictions. In some instances, the journey planning system may provide some alternate routes that may be slightly outside of the parameters set by the traveler in the event that a restriction may be about to expire, which may reduce the cost, complexity, distance, and/or duration of the traveler's journey. FIG. 8B illustrates an interface that provides the available routes/mobility service provider options that may be presented to the user. The route options may include a summary and/or detailed description of the available route, and may indicate which mobility service providers are involved in each route, a departure and/or arrival time for each route, a cost of each route, a distance of each route, a duration of each route, and/or other information associated with a given route. The journey planning interface may enable the user to filter routes based on different criteria such as, but not limited to, a best route, a route with the least amount of walking (or other mode of transportation), a shortest route, a quickest route, departure/arrival times (e.g., closest to the user input times), fewest transfers, lowest cost, transit types (which may include a user being able to select and/or deselect which transit types/mobility service providers are searched for inclusion in the route options), and/or other criteria as illustrated in FIG. 8C.

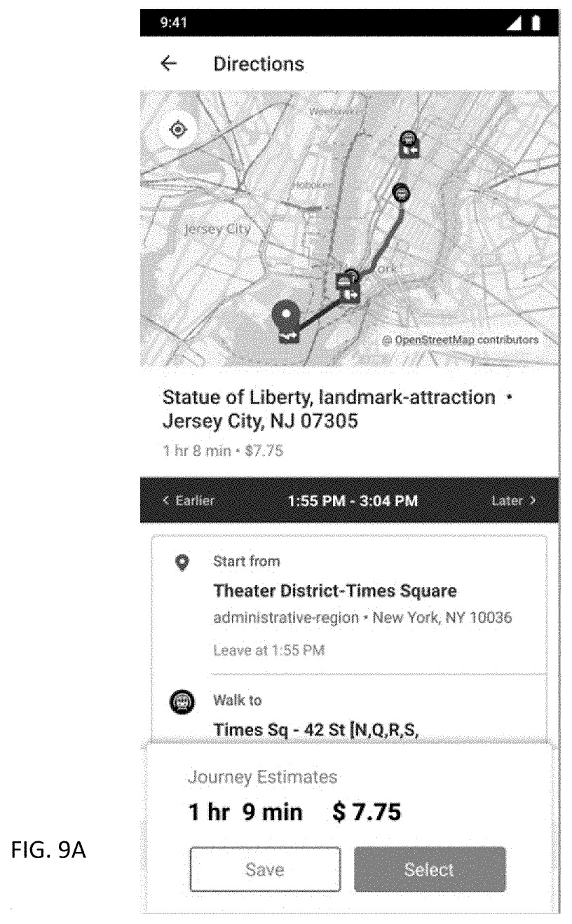

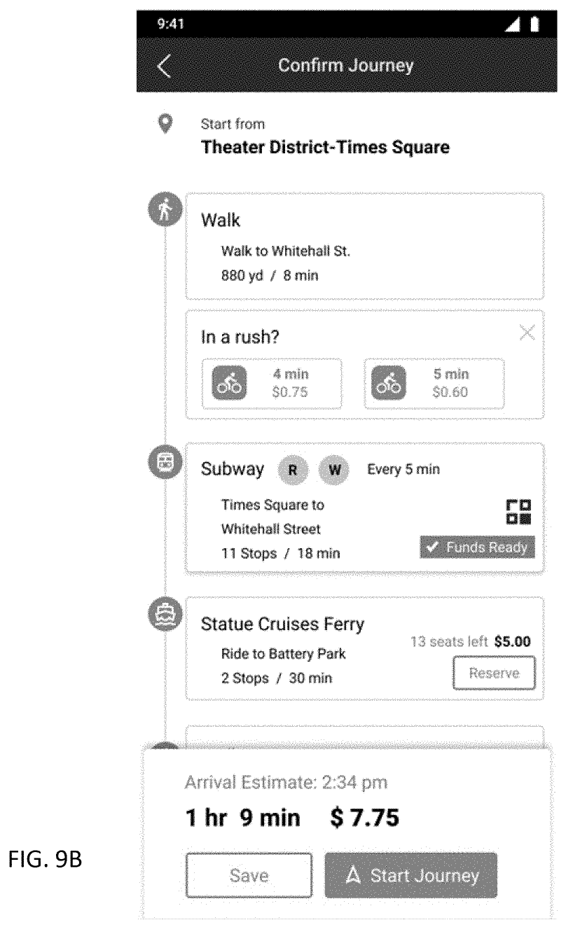

FIGS. 9A and 9B illustrate a journey booking interface, which may enable the end-user to book a selected journey. For example, once an end-user has selected a particular journey option using the journey planning interface, the journey booking interface may provide instructions for completing the journey, such as directions, transit information, expected costs for one or more legs, and/or other information. In some embodiments, the journey booking interface may enable the end-user to reserve and/or pay for one or more transit options provided by one or more of the mobility service providers. This enables the end-user to fully plan, book, pay for, and access transit fare credentials using a single mobile application. In some embodiments, the journey booking interface may provide alternative routing/transit options, which may help if the end-user is behind schedule. For example, the journey booking interface may suggest a bikeshare or other faster mode of transportation during a planned walking leg of the journey.

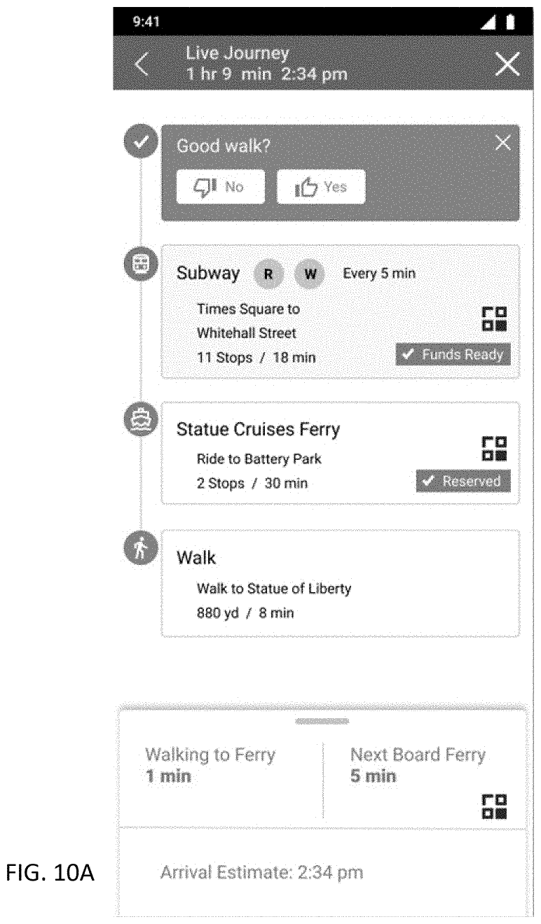

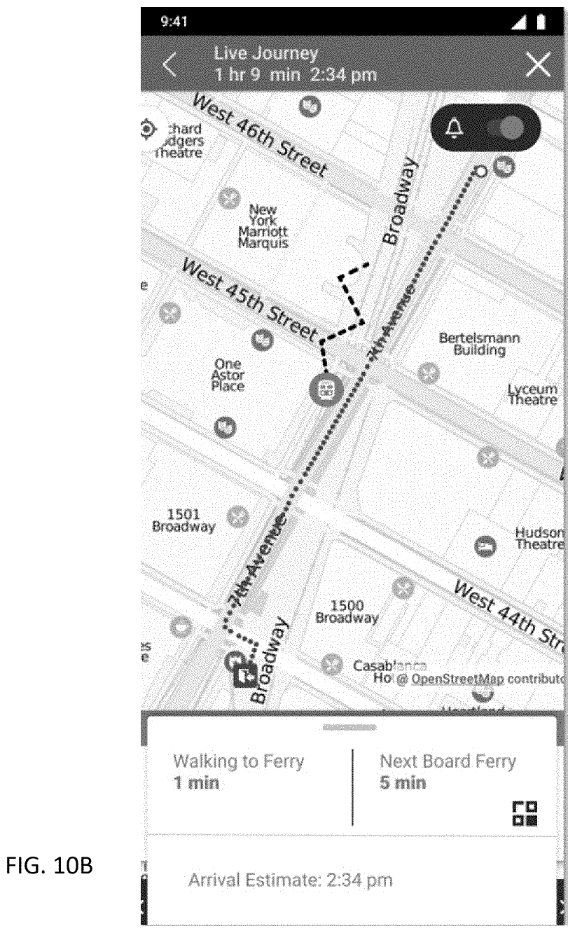

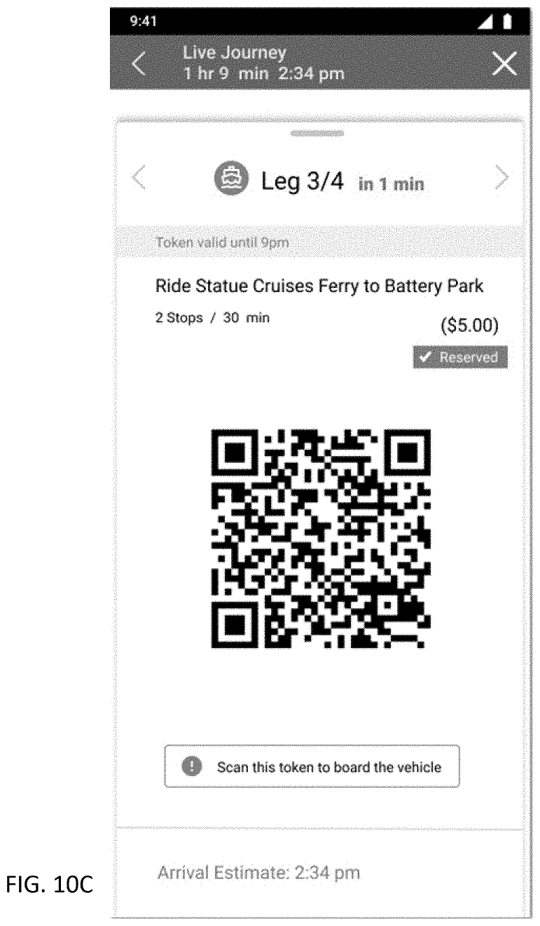

FIGS. 10A-10C illustrate an embodiment of a live journey interface, which facilitates all legs of a particular journey. The live journey interface may include real-time directions, ETAs at destinations, ETDs of one or more transit vehicles, availability and/or location of transit options (such as bikeshare bikes), and/or other information to the end-user upon commencement of a booked or otherwise selected journey. The live journey interface may leverage the clock and/or location services features (such as GPS data) of the end-user's mobile device to provide accurate and up-to-date directions for the end-user to complete the journey. The live journey interface may be viewed as written directions and/or as a map view. In embodiments in which a user has reserved and/or paid for use of a particular service from one or more mobility service providers, the live journey interface may enable the end-user to select one or more transit fare credentials (such as tickets, stored value cards, payment media, etc.) for accessing one or more mobility service provider services. For example, a transit fare or payment media in the form of a barcode, QR code, other machine and/or human-readable identifier may be displayed, a data file containing the fare credentials or payment information may be transmitted (such as using an NFC interface, Bluetooth, and/or other contactless or contact-based communications protocol), and/or other form of access credentials may be selected and provided by the mobile device. In some embodiments, the access credential/payment may be automatically displayed and/or transmitted upon the mobile device determining that the end-user is at a location associated with a particular mobility service provider/booked journey leg.

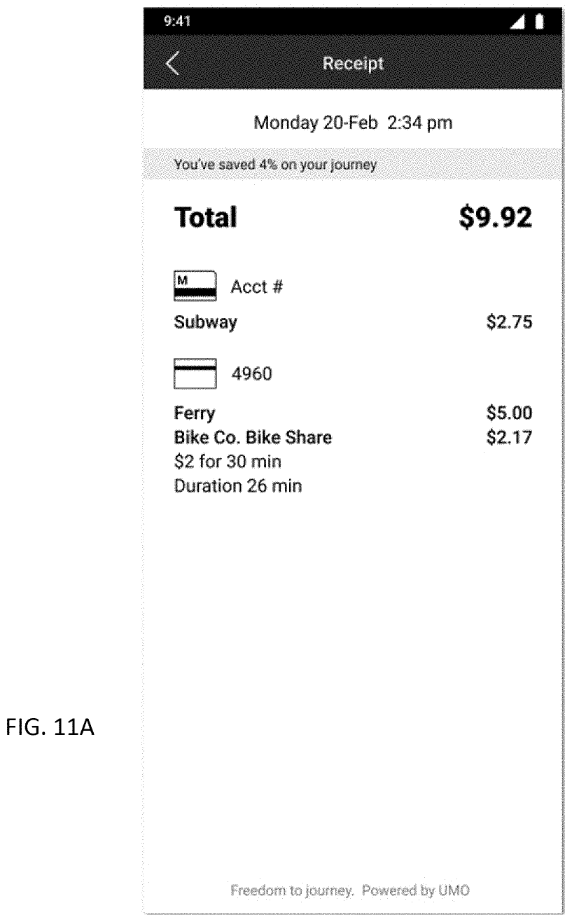

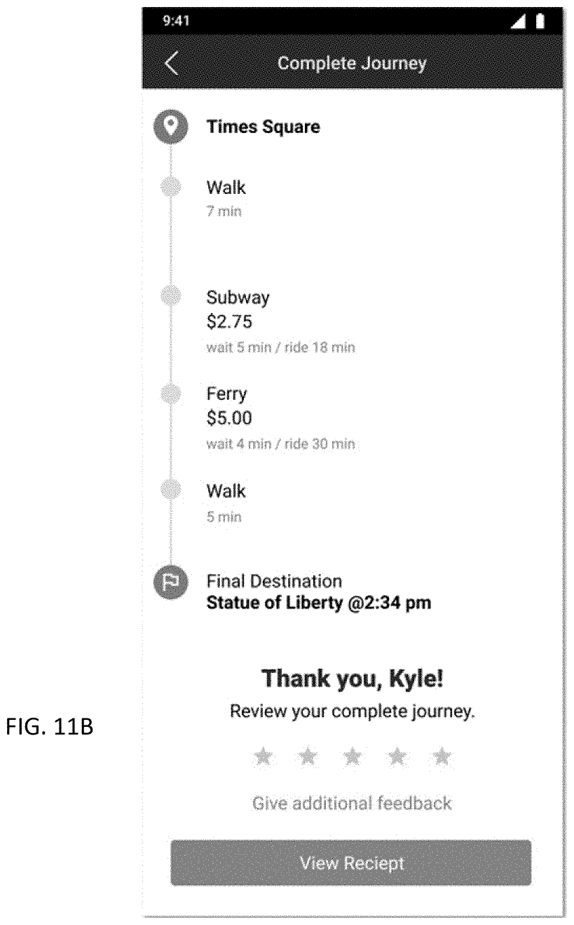

FIGS. 11A and 11B illustrate a journey review interface according to one embodiment. The journey review interface enables the end-user to access and view a receipt or other summary of the journey. This may include a total and/or breakdown of any payments made (including payment sources, mobility service providers associated with one or more payments, and/or other information). The journey review interface may also provide a summary of the journey itself, such as a departure time, arrival time, breakdown of one or more legs of the journey (possibly including cost, duration, distance, begin/end time for the leg, etc.), and/or other information. In some embodiments, a feedback field may be provided that enables the end-user to provide feedback on the trip as a whole and/or related to one or more specific legs of the journey.

Data from the various interfaces of the end-user software from each end user may be provided to the managing authority, which may be aggregated used to populate the various MaaS platform dashboards, which enables the managing authority to view usage and transaction data, monitor transit times, and help better craft policy restrictions that will best achieve desired policy objectives.

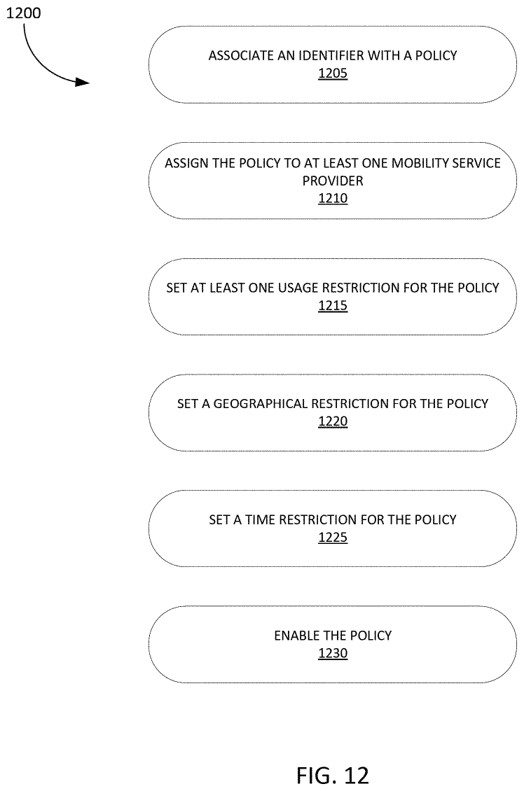

FIG. 12 illustrates a process 1200 for method of implementing a mobility as a service policy. Process 1200 may be performed using MaaS platform 1, such as by a managing authority interacting with one or more of the dashboards described above, including at least the policy dashboard. The process 1200 may begin at operation 1205 by associating the policy with an identifier. At operation 1210, the process may include assigning the mobility service policy to at least one mobility service provider of a plurality of mobility service providers. For example, the managing authority may determine one or more policy objectives (e.g., reduce pollution, reduce congestion, reroute traffic, increase mass transit usage, etc.) and selecting one or more mobility service providers (as well as usage restrictions, geographical regions, time restrictions, etc.) based on the identified policy objective. In some embodiments, to better identify which restrictions and providers to include, the managing authority may view and analyze historical usage and transaction data (such as using the various dashboards described above) associated with the various mobility service providers to better understand the effects of the various restrictions on different mobility service providers. For example, the managing authority may be presented with metrics associated with at least some of the plurality of mobility service providers on a display device. In some embodiments, machine learning and/or other algorithms may be implemented that automatically analyze the effects that various policy restrictions on the different mobility service providers may have on achieving a given policy objective. In some embodiments, the selected mobility service provider(s) may include all of the plurality of mobility service providers that fall into a particular provider type (e.g., rideshare service, a ride-hailing service, a user-operated vehicle service, etc.)

The process 1200 may include setting at least one usage restriction for the mobility service policy at operation 1215. Each usage restriction may limit operation of the at least one mobility service provider when the policy is activated. For example, single-rider rideshare vehicles may be prohibited during certain times to help ease congestion during peak traffic times and to encourage increased mass transit and/or other carpool ride usage. At operation 1220, a geographical restriction associated with the mobility service policy. For example, the managing authority may set the geographical restriction by setting a radius around one or more points of interest, drawing in a boundary on a map interface, otherwise inputting a geofenced area, identifying a set of one or more roadways, and/or otherwise inputting such boundaries. The process 1225 may further include setting a time restriction associated with when the mobility service policy is to be active. For example, the managing authority may set a start and/or end date for the policy, select a time period for when the policy is to be active, set whether the policy should be a single instance (such as for an event) or may be recurring, select a frequency of repeat occurrences of the policy (e.g., daily, weekly, monthly, etc.), as well as designate a date, day of the week, and/or other starting point for the repeating, select which days of the week the policy may be active, and/or otherwise adjust the time restriction of the policy.

The process 1200 may include enabling the mobility service policy at operation 1230. Enabling the policy may include activating the policy such that the policy goes into effect based on the input time restrictions. Enabling the policy may include appending the mobility service policy to a log of prior mobility service policies. Enabling the policy may include communicating the mobility service policy to each of the at least one mobility service provider. Enabling the policy may include communicating a policy contract to each affected mobility service provider. The mobility service provider may review the policy and either send an approval or rejection of the policy to the MaaS platform 1 and managing authority. If the policy is rejected, the managing authority may determine whether to revise the policy, suspend the mobility service provider(s) who rejected the policy, and/or taking some other action.

In some embodiments, once the policy is created, the policy may be submitted to a journey planning service. This may ensure that travelers utilizing the journey planning service to plan, book, and/or execute journeys are prevented from booking travel using any mobility service providers that are unavailable during all or a portion of the user's journey due to the policy. In some embodiments, the managing authority may be presented with and/or otherwise view a log of current mobility service policies on a display device. This may enable the managing authority to view and/or modify the existing policies to achieve various policy objectives.

A computer system as illustrated in FIG. 13 may be incorporated as part of the previously described computerized devices. For example, computer system 1300 can represent some of the components of computing devices that operate the MaaS operator software, MaaS platform 1, the end-user device, and/or other computer devices that facilitate operation of the systems and methods described herein. FIG. 13 provides a schematic illustration of one embodiment of a computer system 1300 that can perform the methods provided by various other embodiments, as described herein. FIG. 13 is meant only to provide a generalized illustration of various components, any or all of which may be utilized as appropriate. FIG. 13, therefore, broadly illustrates how individual system elements may be implemented in a relatively separated or relatively more integrated manner.

The computer system 1300 is shown comprising hardware elements that can be electrically coupled via a bus 1305 (or may otherwise be in communication, as appropriate). The hardware elements may include a processing unit 1310, including without limitation one or more processors, such as one or more special-purpose processors (such as digital signal processing chips, graphics acceleration processors, and/or the like); one or more input devices 1315, which can include without limitation a keyboard, a touchscreen, receiver, a motion sensor, a camera, a smartcard reader, a contactless media reader, and/or the like; and one or more output devices 1320, which can include without limitation a display device and/or the like.

The computer system 1300 may further include (and/or be in communication with) one or more non-transitory storage devices 1325, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 1300 might also include a communication interface 1330, which can include without limitation a modem, a network card (wireless or wired), an infrared communication device, a wireless communication device and/or chipset (such as a Bluetooth™ device, an 502.11 device, a Wi-Fi device, a WiMAX device, an NFC device, cellular communication facilities, etc.), and/or similar communication interfaces. The communication interface 1330 may permit data to be exchanged with a network (such as the network described below, to name one example), other computer systems, and/or any other devices described herein. In many embodiments, the computer system 1300 will further comprise a non-transitory working memory 1335, which can include a RAM or ROM device, as described above.

The computer system 1300 also can comprise software elements, shown as being currently located within the working memory 1335, including an operating system 1340, device drivers, executable libraries, and/or other code, such as one or more application programs 1345, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such special/specific purpose code and/or instructions can be used to configure and/or adapt a computing device to a special purpose computer that is configured to perform one or more operations in accordance with the described methods.

A set of these instructions and/or code might be stored on a computer-readable storage medium, such as the storage device(s) 1325 described above. In some cases, the storage medium might be incorporated within a computer system, such as computer system 1300. In other embodiments, the storage medium might be separate from a computer system (e.g., a removable medium, such as a compact disc), and/or provided in an installation package, such that the storage medium can be used to program, configure and/or adapt a special purpose computer with the instructions/code stored thereon. These instructions might take the form of executable code, which is executable by the computer system 1300 and/or might take the form of source and/or installable code, which, upon compilation and/or installation on the computer system 1300 (e.g., using any of a variety of available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, a risk management engine configured to provide some or all of the features described herein relating to the risk profiling and/or distribution can comprise hardware and/or software that is specialized (e.g., an application-specific integrated circuit (ASIC), a software method, etc.) or generic (e.g., processing unit 1310, applications 1345, etc.) Further, connection to other computing devices such as network input/output devices may be employed.

Some embodiments may employ a computer system (such as the computer system 1300) to perform methods in accordance with the disclosure. For example, some or all of the procedures of the described methods may be performed by the computer system 1300 in response to processing unit 1310 executing one or more sequences of one or more instructions (which might be incorporated into the operating system 1340 and/or other code, such as an application program 1345) contained in the working memory 1335. Such instructions may be read into the working memory 1335 from another computer-readable medium, such as one or more of the storage device(s) 1325. Merely by way of example, execution of the sequences of instructions contained in the working memory 1335 might cause the processing unit 1310 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1300, various computer-readable media might be involved in providing instructions/code to processing unit 1310 for execution and/or might be used to store and/or carry such instructions/code (e.g., as signals). In many implementations, a computer-readable medium is a physical and/or tangible storage medium. Such a medium may take many forms, including but not limited to, non- volatile media, volatile media, and transmission media. Non-volatile media include, for example, optical and/or magnetic disks, such as the storage device(s) 1325. Volatile media include, without limitation, dynamic memory, such as the working memory 1335. Transmission media include, without limitation, coaxial cables, copper wire, and fiber optics, including the wires that comprise the bus 1305, as well as the various components of the communication interface 1330 (and/or the media by which the communication interface 1330 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 1330 (and/or components thereof) generally will receive the signals, and the bus 1305 then might carry the signals (and/or the data, instructions, etc. carried by the signals) to the working memory 1335, from which the processor(s) 1305 retrieves and executes the instructions. The instructions received by the working memory 1335 may optionally be stored on a non-transitory storage device 1325 either before or after execution by the processing unit 1310.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

The methods, systems, devices, graphs, and tables discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein. As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A method of implementing a mobility as a service policy, comprising:
associating an identifier with a mobility service policy;
assigning the mobility service policy to at least one mobility service provider of a plurality of mobility service providers;
setting at least one usage restriction for the mobility service policy, wherein the at least one usage restriction limits operation of the at least one mobility service provider when the policy is activated;
setting a geographical restriction associated with the mobility service policy;
setting a time restriction associated with when the mobility service policy is to be active; and
enabling the mobility service policy.

2. The method of implementing a mobility as a service policy of claim 1, further comprising:
determining a policy objective to achieve; and
selecting at least one of the usage restriction, the geographical restriction, and the time restriction based on the policy objective.

3. The method of implementing a mobility as a service policy of claim 1, further comprising:
appending the mobility service policy to a log of prior mobility service policies.

4. The method of implementing a mobility as a service policy of claim 1, further comprising:
receiving an approval of the mobility service policy from the at least one mobility service provider.

5. The method of implementing a mobility as a service policy of claim 1, wherein:
the mobility service policy is based at least in part on historical usage data of the plurality of mobility service providers.

6. The method of implementing a mobility as a service policy of claim 1, wherein:
enabling the mobility service policy comprises communicating a policy contract to each of the at least one mobility service provider.

7. The method of implementing a mobility as a service policy of claim 1, wherein:
enabling the mobility service policy comprises communicating the mobility service policy to each of the at least one mobility service provider.

8. A mobility as a service computing system, comprising:
a communication interface,
one or more processors; and
a memory containing instructions thereon that, when executed, cause the one or more processors to:
associate an identifier with a mobility service policy;
assign the mobility service policy to at least one mobility service provider of a plurality of mobility service providers;
set at least one usage restriction for the mobility service policy, wherein the at least one usage restriction limits operation of the at least one mobility service provider when the policy is activated;
set a geographical restriction associated with the mobility service policy;
set a time restriction associated with when the mobility service policy is to be active; and
enable the mobility service policy.

9. The mobility service computing system of claim 8, wherein:
the geographical restriction places a restriction on an area comprising at least one of the group consisting of a radius around one or more points of interest, a drawn in boundary, a geofenced area, and a set of one or more roadways.

10. The mobility service computing system of claim 8, wherein:
setting the time restriction comprises setting a recurring time period for the mobility service policy to be active.

11. The mobility service computing system of claim 8, wherein:
the at least one mobility service provider comprises all of the plurality of mobility service providers that fall into a particular provider type.

12. The mobility service computing system of claim 11, wherein:
the particular provider type is selected from the group consisting of a rideshare service, a ride-hailing service, and a user-operated vehicle service.

13. The mobility service computing system of claim 8, wherein:
the instructions further cause the one or more processors to submit the mobility service policy to a journey planning service.

14. The mobility service computing system of claim 8, wherein:
the instructions further cause the one or more processors to present a log of current mobility service policies on a display device.

15. A non-transitory computer-readable medium having instructions stored thereon that, when executed, cause one or more processors to:
associate an identifier with a mobility service policy;
assign the mobility service policy to at least one mobility service provider of a plurality of mobility service providers;
set at least one usage restriction for the mobility service policy, wherein the at least one usage restriction limits operation of the at least one mobility service provider when the policy is activated;
set a geographical restriction associated with the mobility service policy;
set a time restriction associated with when the mobility service policy is to be active; and
enable the mobility service policy.

16. The non-transitory computer-readable medium of claim 15, wherein the instructions further cause the one or more processors to:
append the mobility service policy to a log of prior mobility service policies.

17. The non-transitory computer-readable medium of claim 15, wherein the instructions further cause the one or more processors to:
receive an approval of the mobility service policy from the at least one mobility service provider.

18. The non-transitory computer-readable medium of claim 15, wherein the instructions further cause the one or more processors to:
submit the mobility service policy to a journey planning service.

19. The non-transitory computer-readable medium of claim 15, wherein the instructions further cause the one or more processors to:
present a log of current mobility service policies on a display device.

20. The non-transitory computer-readable medium of claim 15, wherein the instructions further cause the one or more processors to:
present metrics associated with at least some of the plurality of mobility service providers on a display device.
